(19) United States
(12) Patent Application Publication
(10) Pub. No.: US 2013/0138563 A1
(43) Pub. Date: May 30, 2013

(54) SYSTEMS AND METHODS FOR PREPAID MERCHANT PAYMENT SERVICES

(71) Applicants: Clark S. Gilder, Alpharetta, GA (US); Ty Hardison, Atlanta, GA (US)

(72) Inventors: Clark S. Gilder, Alpharetta, GA (US); Ty Hardison, Atlanta, GA (US)

(73) Assignee: GLOBAL STANDARD FINANCIAL, INC., Alpharetta, GA (US)

(21) Appl. No.: 13/482,810

(22) Filed: May 29, 2012

Related U.S. Application Data
(60) Provisional application No. 61/490,383, filed on May 26, 2011.

(51) Int. Cl. G06Q 20/40

(52) U.S. Cl. CPC G06Q 20/4016
USPC 705/44

(57) ABSTRACT

A computer implemented method, a system, and software provides a new processing origination model allowing a new 6^{th} party in payment processing systems and networks, to inspect transactions before they are authorized, enabled or further processed by the payment or settlement network. This new processing delivery system and method may limit or reduce the service operators risk exposure to a defined limit, thereby improving the service providers' ability to manage a known and quantifiable risk level per merchant while limiting the system implementer's total amount of risk and improving both the speed of underwriting and merchant approval process.

### CROSS-REFERENCE TO RELATED APPLICATION(S)

The present non-provisional patent application claims priority to U.S. Provisional Patent Application Ser. No. 61/490,383, filed May 26, 2011, and entitled “SYSTEMS AND METHODS FOR PREPAID MERCHANT PAYMENT SERVICES,” the contents of which are incorporated in full by reference herein.

### FIELD OF THE INVENTION

Generally, the field of art of the present disclosure pertains to electronic payment systems and methods, and more particularly, to prepaid merchant systems and methods.

### BACKGROUND OF THE INVENTION

Conventionally, payment processing networks or systems have a long history, particularly in the U.S., where they go back to the original paper check processing system (including letters of credit or bills of exchange) which preceded credit card, charge card, prepaid cards or debit card “electronic” processing systems and the like along with Automated Clearing House (ACH) or automated debit processing among other electronic payment forms. Over time however, each payment form tends to be modeled on or re-use concepts from earlier payment systems and methods, particularly in the area of sales, distribution, operation or delivery models. While each payment network or “rail” has unique properties and identifiable characteristics, most successful financial payment systems and methods focus on managing the risk of loss from fraud, charge-backs or non-payment during the payment settlement process. The fundamental elements, rules or limits used within a risk management process make them one of the key criteria in distinguishing or defining any particular payment method from other payment forms. The elements of a risk management or loss prevention system become useful in describing some of the advantages that a particular payment delivery model possess or utilizes when processing transactions. Finally, understanding or identifying elements of payment systems risk across the various parties which participate or operate a system becomes one of the key ways for determining the business models, pricing models and therefore profits and or losses incurred by various operating parties.

However, risk management processes are not always easily identifiable, especially by outside parties, primarily for reasons of security among other reasons. Therefore when payment systems and methods are described or defined, elements of risk responsibility may often be obscured by the definitions, labels or identities of the participants. For example, traditionally the card payments industry (including but not limited to charge cards like the traditional Amex “green” or “gold” cards, credit cards, debit cards, EFT, EBT, prepaid, or smart-card enabled cards and other “card like” payment systems and the like) may commonly be described or viewed, at a high level, as a multi-party network system. These card payment network systems are commonly viewed to be composed of the interconnection of five (5) specifically identified parties or functions with each having various roles or responsibilities in delivering or fulfilling a payment process over the network. Yet using the definitions of the five party model it is not always easy to identify which party is the bottom line owner of risk or who will be the party of last resort in assigning losses at various points in time of a payment network settlement process. Thus participating parties may be unaware that they are exposed to unknown risks (or unknowable risk at the time of the initial purchase transaction) when participating in the processing of payments under existing systems and methods, particularly for the parties who facilitate merchant acquiring and processing of payments.

Previous patents such U.S. Pat. No. 5,991,748 by Taskett illustrate concepts to automate the tasks of the payment issuer not the acquirer. Other prior art such as U.S. Pat. No. 6,343,284 by Ishikawa demonstrate ideas to simplify payee acceptance of a transaction by an unknown payor but do not focus on simplifying the sales and marketing of that process to the payee or their overall risk levels. Other examples focus on the distribution of prepaid cards such as U.S. Pat. No. 6,169,975 by White to minimize the cost or reduce fraud while they do not focus on the payee's processing of the service or in the case of the White patent operating the long distance phone service network operation such as would be done under the PPMA payment processing agreement. More recent patents such as U.S. Pat. No. 7,600,692 by Call focus on providing “retail kiosks” for consumers or customers (payors) to make prepaid deposits and manage purchases for goods and services from their prepaid account but they do not help the merchant's payment processing system provider reduce operating risks nor do they simplify the Independent Sales/Service Organization or “ISO” sales service and support process provided to the merchant or payee. Similarly, U.S. Pat. No. 7,606,760 by Hutchinson et al provide a virtual consumer prepaid account for merchants to debit transactions against but this system does not simplify the ISO process and instead helps the merchants offer goods for sale to consumers who have prepaid accounts. Alternatively, efforts to simply the selling of a service by a merchant or business such as U.S. Pat. No. 7,634,446 by Jones do not address the need to process the payment and instead focus on simplifying the consumers experience in purchasing prepaid services from a business. Efforts to simplify payments such as U.S. Pat. No. 7,814,018 by Sosa, focus on enabling secure and anonymous payments from payors to payees under ecommerce scenarios however they do not enable risk reduction or simplified selling to the merchant or payee, particularly for non-ecommerce sales such as retail POS environments. Attempts such as U.S. Pat. No. 6,793,135 by Ryoo focus on providing a closed loop prepaid payment service to both the payor and payee but do not allow outside sales agents to operate or participate in the delivery of the service and thus do not mitigate their risks. Finally, prepaid card management systems such as U.S. Pat. No. 7,813,982 by Holme focus on enabling derivative payments for options or futures under fixed terms between payor and payee yet they do not apply to any purchase transaction nor cover the risk of an acquirer. The pre-authorized system shown by Gupta in U.S. Pat. No. 7,742,994 does not provide prepayment of fees and focuses on authorization not processing origination. Thus it can be easily seen by outside parties or by those skilled in the art of payment processing or acquiring that a new type of Prepaid Merchant Account is needed in the market by 100% risk enabled ISOs, aggregators or payment acquirers to reduce their risks and improve profits.

### BRIEF SUMMARY OF THE INVENTION

In an exemplary embodiment, a computer implemented method includes registering a merchant; receiving transaction details from the merchant; evaluating the transaction details based on the registration of the merchant; if the evaluating is rejected, notifying the merchant of the rejection; and if the evaluating is accepted, forwarding the transaction details to a payment processing network. The computer implemented method further includes determining a plurality of rules for evaluating the transaction details from the merchant, and utilizing the plurality of rules in the evaluating the transaction details. The computer implemented method further includes, if the evaluating is rejected, resubmitting the transaction details through one of reducing a value, a size, or an amount of the transaction details. The computer implemented method further includes receiving a prepayment of fees from the merchant thereby reducing an overall risk level associated with transactions for the merchant; and evaluating the transaction details based on the prepayment of fees and rejecting the transaction details if associated fees exceed the prepayment of fees. A system and software stored in a non-transitory computer readable medium are also described.

### BRIEF DESCRIPTION OF THE DRAWING(S)

Exemplary and non-limiting embodiments of the present disclosure are illustrated and described herein with reference to various drawings, in which like reference numbers denote like method steps and/or system components, respectively, and in which:

FIG. 1 is a diagram of the five parties of an electronic payment processing network;

FIG. 2 is a diagram of an Automated Clearing House (ACH) network using a four (4) party model;

FIG. 3 is a diagram of a five party network for credit card payments based on the electronic payment processing network of FIG. 1;

FIG. 4 is a diagram of a network for payments based on the electronic payment processing network of FIG. 1;

FIG. 5 is a flowchart of a PPMA method;

FIG. 6 is a flowchart of data flows in a PPMA method; and

FIG. 7 is a flowchart of an exemplary credit card authorization method.

### DETAILED DESCRIPTION OF THE INVENTION

In various exemplary embodiments, a computer implemented method, a system, and software provides a new processing origination model allowing a new 6^{th} party in payment processing systems and networks, to inspect transactions before they are authorized, enabled or further processed by the payment or settlement network. This new processing delivery system and method may limit or reduce the service operators risk exposure to a defined limit, thereby improving the service providers' ability to manage a known and quantifiable risk level per merchant while limiting the system implementer's total amount of risk and improving both the speed of underwriting and merchant approval process.

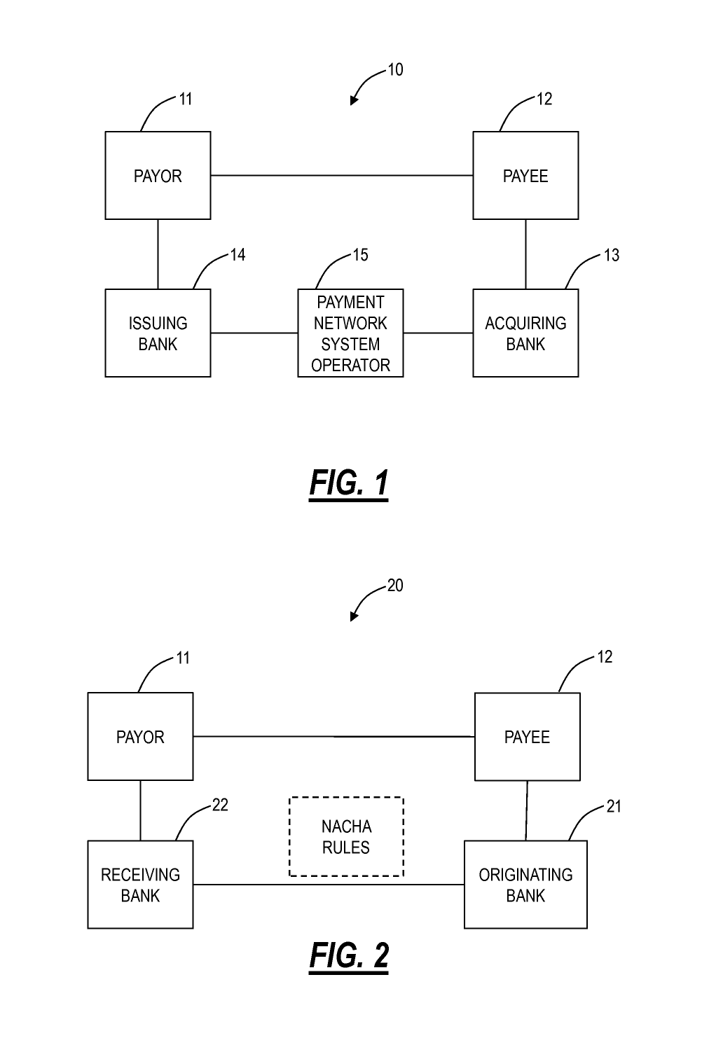

Referring to FIG. 1, specifically, the five parties of an electronic payment processing network 10 may be labeled as follows: a first party in these systems is the holder of a payment form or branded network payment account holder (i.e., a payor 11), the second party is the payment acceptor or merchant (i.e. a payee 12), the third party is an acquiring bank 13 or the bank which accepts and facilitates the clearing of payments on behalf of or for the benefit of the merchant (the payee 12), the fourth party is an issuing bank 14 (i.e. the bank that issued the card or payment form to the payor, who may or may not extend credit to them, who may provide customer support, billing and collection of the actual payment flow from the payment account holder or “customer” or payor 11 to the other parties) and finally the fifth party is an actual “brand” or payment network system operator 15—e.g. Visa (V), MasterCard (MC), Discover (D), American Express (Amex) and the like, which connects all of the parties together under a well known brand identity with defined operating, pricing, processing and settlement rules. Note that the American Express card network operates a modified version of the “five party” network for card payments (i.e. it is a three party model including payor, merchant and Amex) in that Amex traditionally has performed the roles of both the issuing bank 14 and the acquiring bank 13 as well as the network operator 15 who sets the payment issuing and acceptance rules (the network rules of all card payment forms are herein included in full by reference). Additionally, ATM network or PIN debit card network operators function in a similar manner facilitating origination, routing and settlement of payment requests between customer, merchant, bank or ATM operator and other payment networks or alternative payment processors, originators or recipients and the like.

Referring to FIG. 2, in a similar manner, an Automated Clearing House (ACH) network 20 follows a related business and processing model for its electronic payment services using a four (4) party model: the payor 11, the payee 12, an Originating bank 21 (or Originating Depository Financial Institution—ODFI, who is the processor and or sponsoring bank of the payee) and a Receiving bank 22 (or Receiving Depository Financial Institution—RDFI) who debits the payor's bank account to initiate the payment transfer back to the ODFI who processes it on behalf of the payee. In the case of ACH payments, the National ACH Association (NACHA) provides the processing and settlement rules (herein included in full by reference) in a similar manner to the Visa, MasterCard or American Express network model. Various network operators, with the Federal Reserve being the largest, provide connectivity to clear or exchange NAHCA files between ODFI and RDFI. The most common payment usage of the ACH method is for Online Bill Payments (OLBP) or Electronic Bill Presentment and Payment (EBPP), ecommerce and or person to person payment (PayPal and the like) and all of these payment forms may be seen to function at a high level using a similar business method, pricing and sales as well as risk management models to the card payment methods. Additionally, the Federal Reserve and private third party networks facilitate the check payment settlement network, including the image settlement rules set by ECCHO (herein included by reference in full), in a role similar to ACH networks and or card or electronic payment network systems.

Thus, at an overall or high level, the payments marketplace can be seen to be a collection of cooperating parties working together to provide customers (payors and payees) with a comprehensive set of payment processing services that operate under a consistent set of business rules, pricing or fee structures and common standards or rules such as risk management or security requirements, electronic file formats, electronic messages or records and the like to facilitate payment transactions while minimizing risk of fraud and maximizing customer and merchant acceptance of their payment form in the marketplace. One example of a cooperating set of operating rules is the compliance rules of the Payments Card Industry (PCI) Data Security Standards, herein included in full by reference including the newest forms or modifications or custom system rules. Another example is the Industry Standards Organization (ISO) electronic messaging standards for financial transaction card originated messages—Interchange message specifications such as the ISO 8583 format. Note that business models, rules, pricing, and often compliance, security and risk management specifications may vary by payment form or provider or operating party within a network system but often these elements may be dictated by the branded payment network operator as a requirement on all or some of the participating parties.

Beyond the five well known parties that are commonly identified in the card payment networks, there are additional parties that help connect or operate components of a payment or transaction processing network to facilitate key aspects of the processing lifecycle. These additional parties provide critical or value added services for or on behalf of one of the existing five parties. Some examples of these additional parties or vendors are: Point of Sale (POS) equipment providers who facilitate magnetic stripe card “swipe” transactions including the “swipe box” terminal providers such as VeriFone, Hypercom, Ingenico and the like. Other examples include electronic network connection “switch” services which acquire payment “messages” and process and or route them to appropriate processing operators which link POS transaction “swipes” to the acquiring and issuing banks—examples of these are vendors such as First Data, TSYS, Global Payments, and the like. Additionally, non-POS environments such as ATM or PIN debit networks, Internet websites, ecommerce transactions and the like may flow through ATM machines, PIN debit keypad devices, ecommerce shopping carts and or “payment gateways”, aggregators or network providers such as NYCE, Star, CyberSource, PayPal, Square, Google Checkout, Authorize.NET and the like who facilitate payment transactions by routing the transaction details to switches and or other vendors or processors in order to reach banks and or payment networks. Businesses or merchants may also purchase or utilize other business transaction processing services such as invoice or lockbox services, loyalty or rewards points tracking and processing, or rebate or coupon redemption processing services, all of which may flow through similar acquiring and processing networks or new alternative payment processing services and the like. Finally, new “mobile” transactions may be made by customers (payors) or received by merchants (payees) using cell phones (or smart phones, or tablet devices or PDAs such as the Apple iPador other digital assistants and the like) which may use one of a variety of “near field communication” (NFC) methods, barcode scanning, human biometric methods as well as the more traditional card “swipe” models to initiate a payment transaction. These transactions allow the merchant (payee) to charge the customer (payor) for goods and or services and facilitate their purchase(s) by one of a variety of card or account numbers, tokens, one time use numbers, pseudo IDs, GUIDs, stored value identifiers, e-wallets, and the like which may perform a similar if not identical function to the traditional plastic card payment “swipe” transactions. Finally, there are various sales, service and support parties, widely known as Independent Sales/Service Organizations or “ISOs”, which facilitate the recruitment of and selling to merchants to accept (or “acquire”) many of these payment forms, along with the delivery, training, management and operational effectiveness of a payment form or method and any required equipment within a targeted market. ISOs that sell a specific payment form to payment receivers (payees) usually explain the pricing, delivery and operation of these payment services to their customers across the various retail stores, merchants or in general any business desiring to have payment processing services. Thus, given the interconnectedness, complexity and possible combination of parties operating to originate, clear and settle a payment transaction, it can be seen by those skilled in the art that the understanding of and at times assignment of risk or ultimate responsibility for a transaction across these various entities may be confusing or at times even hidden from the participants and may unfortunately be a variable or subjective matter to some of the parties or unknown to any or each party before a transaction Occurs.

The business models used to sell and service payment processing used by merchants, businesses or payees in general are delivered by various parties at each level or “tier” as measured by payee size or transaction volume. Using traditional industry definitions, the largest stores and merchants (e.g. Wal-Mart, Safeway, Macy's, The Home Depot, Amazon, EBay and the like) have the highest volume of transactions and are known as “Level 1” merchants and are sold and managed directly by the large banks and or payment processors such as First Data. Large but less well known merchants with slightly smaller transaction volumes are “Level 2” merchants and are likely to be sold and serviced directly by the banks or processors. The common or traditional medium size stores, businesses or merchants who have smaller but still sizeable (in total dollar amounts or transaction unit volumes) are known as “Level 3” merchants and may be sold and serviced by various parties including ISOs. Merchants who fall beyond or outside the traditional Level 1-3 transaction model definitions were commonly or informally called “Level 4” merchants. These Level 4 merchants number in the millions and they make up the vast majority of customers for the ISOs and or aggregators or payment gateways to sell and service. Additionally, a new class of “Level 5” merchants may be defined to be the tens of millions of small merchants, mobile merchants, ecommerce websites or mobile phone users who may sell small quantities, or who sell occasionally or seasonally or periodically or intermittently or informally, yet who desire to accept a payment via their website, mobile phone, Apple's iPad, a PDA or similar device such as a POS to originate a payment transaction on their behalf for goods or service they may wish to sell.

Included for definition and illustrative reference and incorporated in full by reference below are the Visa definitions of merchant levels which illustrate how ISOs are utilized to primarily sell and manage smaller Level 4 and sometimes Level 3 merchants:

| Level/ | | |
|---|---|---|
| Tier * | Merchant Criteria | Validation Requirements |
| 1 | Merchants processing over | Annual Report on Compliance |
| | 6 million Visa transactions | (“ROC”) by Qualified Security |
| | annually (all channels) or | Assessor (“QSA”) |
| | Global merchants identified | Quarterly network scan by |
| | as Level 1 by any Visa | Approved Scan Vendor (“ASV”) |
| | region ¹ | Attestation of Compliance Form |
| 2 | Merchants processing 1 | Annual Self-Assessment |
| | million to 6 million Visa | Questionnaire (“SAQ”) |
| | transactions annually | Quarterly network scan by ASV |
| | (all channels) | Attestation of Compliance Form |
| 3 | Merchants processing 20,000 | Annual SAQ |
| | to 1 million Visa e-commerce | Quarterly network scan by ASV |
| | transactions annually | Attestation of Compliance Form |
| 4 | Merchants processing less | Annual SAQ recommended |
| | than 20,000 Visa e-commerce | Quarterly network scan by ASV |
| | transactions annually and all | if applicable |
| | other merchants processing up | Compliance validation require- |
| | to 1 million Visa transactions | ments set by acquirer |
| | annually | |

* Compromised entities may be escalated at regional discretion
¹ Merchants meeting Level 1 criteria in any Visa country/region that operates in more than one country/region is considered a global Level 1 merchant. Exception may apply to global merchants if no common infrastructure and if Visa data is not aggregated across borders; in such cases merchant validates according to regional levels. An example of Visa merchant tiers, incorporated fully by reference herein, is found at usa.visa.com/merchants/risk_management/cisp_merchants.html.

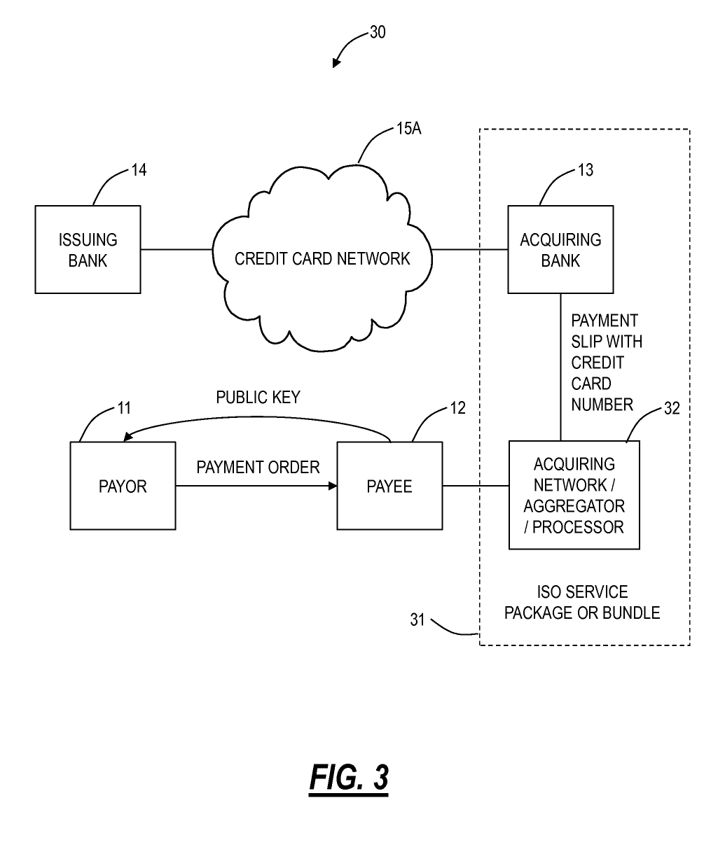

Referring to FIG. 3, in an exemplary embodiment, a diagram illustrates a five party network 30 for credit card payments based on the electronic payment processing network 10 and also shows the role of the acquiring network or aggregator 32. In the network 30, the payment network system operator 15 is a credit card network 15A. The payor 11, i.e. the buyer, submits a payment order (e.g., electronically via Secure Socket Layer (SSL) or the like) and the payee 12, i.e. the seller, can provide a public key. The payee 12 provides a payment slip with relevant information including the credit card number to the acquiring bank 13 which processes the transactions via the network 15A to the issuing bank 14. The traditional five party model was designed, organized and evolved over time in order to grow the overall market availability and acceptance of a particular payment form by each party. One method for growing acceptance was the recognition of and eventually standard practice within the network 15A that various parties needed to be provided with a set of platform services to help them operate their component of the system at reasonable cost and risk levels. For example payment issuers (banks 14 who issue cards to cardholders or payors 11) as well as payment acquirers (merchants or payment acceptors 12 and their banks 13) may both have similar needs but also different sets of needs from these operating platform services. These platform services may include but are not limited to: branding, sales, marketing, customer billing and support, facilitating and managing the risk of extending credit to individual card or account holders, managing the risk of theft or account fraud as well as the risk of allowing merchant businesses to accept payments and finally facilitating the generation or operation of electronic messages or transactions via switches or routing equipment by network acquirers and processors. For example, the card payment network 15A model accomplishes broad acceptance of their form of payment by delivering some aspects of these platform services through the creation and management of their trusted brand or identity. This branded payment form is issued by a bank 14 operating under a defined set of rules, guidelines or business models which allows them to issue a payment card or method to their customers. The issuing bank's customers (payor 11) agree to accept and use this branded payment method because they perceive it to be useful in making purchases from merchants who accept this payment type as well as believing that the issuing bank 14 may protect them from fraud and or merchant (payee 12) misconduct. On the other hand the same card or payment brands may coordinate a set of platform services, rules or business models which are required to be adhered to in order for acquiring banks 13 and or their partners the aggregators or acquiring networks 32 to acquire transactions from merchants (payee 12) who accept the specified or branded payment form issued by the network 15A. Note that the merchants (payee 12) may agree to accept this payment form because they believe that there is a set of customers (payor 11) who have this payment method and that they will get paid in a timely manner without having to manage the individual customer payment or credit payment risk as well as payment collection process. The merchant generally holds this belief because they trust the brand or payment network operator 15A to deliver payment settlement by managing their relationship with the customer (payor 11) and the issuing bank 14 on the other side of the network model. In addition, the merchant knows that their ISO 31 and or the acquiring service provider 32 and or acquiring bank 13 will also enforce rules on the merchant 12 to enable the network 15A and issuing bank 14 to perform their jobs in a timely and efficient manner. That is, the merchant 12 believes they will be paid because they trust that the customer's issuing bank 14 or entity as well as the card or payment network operators 15A will closely monitor the card holder (or customer) spending levels, transaction types and amounts to ensure that the customer can or will pay their bill on time and as agreed upon. Thus the merchant 12 is willing to accept a “net amount” for the transaction, which is calculated as a small percentage discount off of the total amount of the purchase transaction, in exchange for offloading a variety of risks, costs or operational complexities (including settlement) to the payment network provider 15A or acquiring bank 13 or issuing bank 14 or acquiring partners 32 and or other parties. By comparison, if a merchant accepts a paper check as payment, the check may clear at par or full face value, but the merchant may face the risk of a bad check, or one returned for insufficient funds and even if it is paid in full they may be charged a deposit or processing fee and possibly check validation or guarantee fees. Merchants 12 may ask customers to sign up for “auto draft”, echeck or direct ACH debits, particularly for recurring bills or payments but these transactions have costs charged by the ODFI 21 and or processor 32 as well as the overhead of a merchant reserve or holdback account at the ODFI or acquiring bank 13 to cover future reversals, revisions or charge-backs. In addition, many customers hesitate to sign up for such payments, preferring to pay by paper check or credit card. Finally, there is a cost to accepting cash including the risk of theft and or the cost of an armored car service to transport large amounts of cash. Thus all forms of payments that customers (payors 11) and merchants (payees 12) may choose from have advantages and disadvantages yet they may also require the merchant or payee 12 to have access to additional processing and servicing networks to complete a transaction.

At each level, tier or size of merchant 12, the largest component of the total discount amount or fee that merchants may pay under the “card model” is due to a component commonly called bank or network “interchange” or sometimes it is known as a “discount” fee. It is the interchange fee which is paid to the issuing bank 14 as an incentive or compensation for their work in acquiring, servicing and supporting the payor 11 using a particular payment form, particularly when the payor 11 pays no yearly fees, carries a credit balance and pays their bill on time every month. This type of fee, pricing model or reimbursement structure is widely used, imitated or modeled after by the non-card or alternative payment providers (e.g. PayPal or alternative payment networks, aggregators or processors) and as such has become a de facto pricing model used across many payment forms or models. Note that network interchange fees may vary widely by industry type, card type, method or form of input acceptance, transaction dollar size or volume, as well as many other possible criteria. The enormous variability of charges therefore results in hundreds of potential rate and fee combinations for the ISO 31 to explain, manage and support when they quote a single “discount” fee to the merchant for the payment services they offer.

A merchant 12 may typically view this payment processing discount fee offered by the ISO 31 or other payment network party as a marketing and sales cost which they are willing to pay to gain both increased customer volumes and access along with the opportunity to sell more goods to their customers (e.g. customers may make more purchases with credit then with only the cash they have on hand). Merchants 12 agree to conform to these payment processing service rules knowing that a typical transaction will cost them a small discount amount—common discount percentage ranges from 1% to 3% depending on the type of transaction, transaction properties and risk (type of goods sold, merchant and or customer properties, type of card, and the like) however rates do vary outside of that range based on the ISO, acquirer, bank or network offerings thus merchants, businesses or payees may pay more or less.

To complete a sales transaction, the merchant 12 (or their electronic equipment) acquires or receives payor 11 payment method data from a variety of input methods (i.e. via a direct or a telephonic conversation with the customer, or via direct customer input such as into a shopping cart or web check out form, or via a plastic card “swipe” or by reading an e-wallet device using magnetic, barcode or NFC enabled readers connected to a POS or similar device, or via a NFC transmission or the like connected to a mobile phone or iPad, or other well known input methods) and then this critical payment slip or payment data set (which may include items from the list of but not limited to a customer card number, customer ID, GUID, one time transaction code, bank BIN number, bank Routing/Transit number, checking account number, check number, PIN number, merchant ID, transaction line item details, sales and use taxes, total amount, date, or other data items, including a properly formatted message) is transmitted or sent from the merchant 12 to the appropriate payment network 15 and bank(s) 13/14 via the services of a payment acquirer, aggregator, switch or gateway processor 32 or the like. These parties continue the payment processing efforts using the payment information to route the transaction to the appropriate payment network 15 party, such as a card network 15A, and ACH network including the Federal Reserve network, or the appropriate card holder's issuing bank or other party such as an alternative payment processor such as PayPal, either in a serial sequential manner, or in a batch or in parallel or at the same time as may be appropriate or specified by the payment network for the services provided. This payment transaction processing may include having the transaction details examined using a set of operating rules, customer policies, and general business model rules and criteria which may include factors such as credit worthiness, regulatory compliance, security standards, risk management models or guidelines, customer specified rules or conditions, merchant validity, and or other conditions in order to come to a final decision of approving or rejecting the transaction for payment. Finally, financial settlement follows this transaction approval step.

Assuming a successful (or approved) transaction, the merchant 12 expects to receive payment settlement as a “net amount” (i.e. after discounting) as a deposit into their “merchant bank account” at the acquiring bank 13 after a short processing and holding period (defined by their acquiring bank 13 rules and or network card 15A rules and or acquiring processor 32 rules and or ISO 31 rules). Once the funds have cleared into their merchant account, the merchant 12 may specify to the acquiring bank 13 how they will access, receive or transfer these funds to other accounts or otherwise utilize the funds received as completion of the customer or cardholder purchase transaction but with the knowledge that customer or bank charge-backs may still occur down the road in the event of fraud, disputes, returns or similar future debits etc. This unknown future risk introduces complexity to the acquiring side and reducing all forms of risk to the ISO 31 or acquiring party 32 or acquiring bank 13 or payment network 15 is a key aspect of the invention.

At an overall level, the payment networks 15 (Visa, MasterCard, Amex, PayPal and the like) can be viewed to operate their systems utilizing an extensive set of business model and transaction rules to facilitate and process payments along with a complex fee model or structure (commonly known as interchange, discount rates or service fees) which are used to reimburse the various parties involved across the entire flow of the payment transaction. The total fee amount or “discount amount” (i.e. the sum of interchange, per item transaction fees, network or processing fees, monthly fees and the like) is then allocated between the various parties including the issuing bank 14 (for extension of credit, billing services, support and the like), the acquiring bank 13 (for settlement of the transaction including facilitating the payment rules including processing charge-backs and other post-purchase transaction conditions), the electronic network acquiring processor 32 (for various network connectivity, security as well as processing work), any merchant sales or service providers such as ISOs 31 and finally to themselves (the network operator 15) for their marketing, branding, operating and sales efforts that they provide on behalf of the brand and or entire payment system.

The business or merchant 12 who is selling goods or services and submitting transactions for payment processing generally agree to accept less than 100% of the sale amount for payment because they trust that the other parties involved in these payment networks 10 will perform their role reliably, expeditiously and enforce the funds collection process from their customer within a reasonable time period. The entire payment network 10 promotes this trust by implementing or providing various monitoring methods to track the customer's and possibly the merchant's purchase or sales behavior, along with the types and volumes of transactions flowing to and from these parties as well as many other risk attributes required by a trusted payment transaction system. When each party in this model lives up to the terms of their agreements, everyone benefits from the successful operation of these multi-party models as they provide a smooth and predictable set of profitable payment flows between the various parties to everyone's benefit.

Traditionally, a payment method or form is “delivered” or facilitated into the marketplace via a variety of business functions such as marketing, sales, transaction processing operations and billing/collection support. First, the various payment network companies 15 such as Visa, MasterCard or PayPal including the various Online Bill or Electronic Bill Payment providers or other payment service delivery methods and the like, may market directly to consumers to influence their choice of payment method usage. Typically the “issuing banks” 14 or alternative payment network operators take on the role of marketing directly to customers (payors 11) to enroll them in a specific payment program. On the transaction acquiring side of the payment market are the merchants 12, the processors 32 and the acquiring banks 13 or service providers 31 who enable merchants to accept these network operated 15 (V, MC, Amex, PayPal and the like) payment forms. Typically, data processor networks 32 may provide data processing services to acquiring banks to enable them to process and settle payments made by customers at the merchant's POS device, store or online website and the like. Merchant acquirers are vendors who service merchants who want to accept card payments and settle these transactions through what is known as a “merchant account” which is provided by the acquiring bank 13 to the processor or acquiring vendor 32 or ISO 31 to facilitate the merchants (payee 12) receiving their “net amount”. Note that aggregators 32 may function as the “merchant of record” but essentially they aggregate or concentrate all of the individual transactions of their downstream merchants into a larger pool in order to facilitate merchants who cannot open their own account and or who desire the features or services offered by an aggregator such as PayPal and the like. Finally, these merchants pay discount fees to the ISO 31, acquirer or aggregator 32 as compensation for the sales, underwriting, training, setup or “onboarding”, servicing, operations, security and risk management or other services that they or the various participants who enable or facilitate the transaction may provide or require to enable their transactions to occur.

Third party payments aggregation (TPPA) is a general description used for merchants 12 that are selling a product or service that they do not own. One of the best examples of a TPPA (or aggregator) is PayPal as they facilitate the exchange of money between two parties. Merchant Aggregators or Payment Aggregators are service providers through which e-commerce merchants may process their payment transactions. Aggregators allow merchants 12 to accept credit card and bank transfers without having to setup a merchant account with a bank 13 or card association or network 15. The aggregator provides the means for facilitating payment from the consumer, via credit cards, stored value accounts or bank transfer and alternative payment forms and the like, to the merchant. The merchant is paid by the aggregator under the agreed to policy or contract terms including any charge-back or hold-back rules or procedures and the like.

There are different types of TPPA's, for example, an online air travel booking site may charge for both their service fee and the actual airfare in a single transaction. If the merchant 12 were only charging their service fee, they would not fall into the TPPA category as they are simply charging for the service they provide. But because they are also charging a credit card for a product they do not own, an airfare ticket, they fall into the TPPA category. The value proposition of a TPPA is clear to both consumers 11 and merchants 12, but the increased risk is not normally understood as well by the merchant. There are two reasons why TPPA's are considered higher risk in the credit card processing industry: 1) the merchant has reduced control over the quality and delivery of the product being sold, and 2) the merchant is being trusted to pay the third party for the money they've collected on their behalf. As an example of TPPA risk, over a 30 day period an ecommerce merchant sells $1,000,000 worth of tickets for a third party concert event (something they don't control or own). The merchant could collect the $1,000,000 dollars from the cardholders, not buy the tickets from the event organizer and then skip town with a suit case full of money. Each customer would initiate a charge-back because they never received the tickets they purchased. When the charge-backs are initiated, the issuing bank will credit the cardholders account so the merchant processor will in turn try to debit the merchant's account which does not have any money. The example could have been caused by the event organizers canceling the event at the last minute for legitimate reasons and then refuse to refund the merchant who sold the tickets on their behalf. Either way, the point is that an unrelated third party greatly complicates the risk of processing payments. Because the card associations or networks 15 have discouraged the practice of TPPA and the increased risk, most ISO 31 or merchant account providers are justifiably reluctant to underwrite these types of accounts. That is not to say that TPPA merchant accounts cannot get approved for processing, it is just more difficult and the underwriting conditions will more likely include a reserve and other similar safeguards against risk, fraud and higher charge-back amounts.

Looking at the model beyond the level of the network “brands” 15 (e.g. Visa), the consumer and the merchant for now, the actual work of the payments industry may be modeled as a two sided market comprised of a “payment method” (e.g. Visa cards or PayPal and the like) provided by an issuing bank or alternative payment network and the merchant acquiring banks (or alternative payment processors and the like). Traditionally, the network operators 15 and issuing banks 14 market and sell their services directly to the account owners and or cardholders (payors 11) in order to incent them to utilize their particular form of a branded or identified payment and therefore derive the benefits of the usage of that form by their customer. Payment account holders may pay a yearly or monthly fee to use a payment form (ex. one or more cards or alternative payment forms) as well as they may pay an interest rate to the “issuing bank” or service operator for all borrowed funds (i.e. any extension of credit by the issuing bank to the customer) or they may pay a per transaction service fee or combinations thereof. Account holders desire to be customers of card brands or payment networks 15 who have many merchants 12 who accept their branded form of payment; therefore to be successful in a dual sided business model, it is equally important for a payment brand or method to focus on the merchant acquiring or acceptance side of the model as well as the customer issuing and usage side. Therefore, a critical component of a payment network's success is how well a payment form is sold, serviced and supported at the merchant side of the payment market process.

Merchants 12 who accept payment methods use special accounts which are delivered to the market through a combination of banks, network systems, switches or processors along with Independent Sales/Service Organizations or “ISOs” 31. Additionally, any “merchant acquiring” network such as PayPal, Square and other alternative payment networks or payment forms may be considered to be in the business of providing ISO like services as they act as payment transaction “aggregators” who consolidate transactions from many small merchants under a master merchant account. Unlike the issuing side of the payments business where issuing banks or providers market, sell and support their card holding or payment enabled customers directly, the acquiring banks have not commonly excelled at the operations and servicing of card processing technology and networks as well as managing the sales teams who sell these services to merchants. Therefore, acquiring banks 13 or alternative payment networks have traditionally outsourced these functions to third parties in exchange for their sharing with them a cut or slice of the service fees from processing the merchant's transactions. Thus, the sale of payment processing services to the merchants 12 is commonly performed outside of the acquiring bank and or processor/acquiring vendor by the ISOs 31 or aggregators 32. Acquiring banks 13 also prefer to collect fee income while offloading the financial risk of merchant transactions to their ISO 31 sales and service partners because the ISO may typically qualify the merchant when signing them up for a payment service offering. In general, merchant acquiring poses financial risk in the form of cardholder charge-backs, general card theft and fraud, merchant fraud and merchant bankruptcy—all of which the payment networks 15 and acquiring banks 13 may, in turn, pass down to the merchant's ISO 31 if needed.

Using an affiliated or contracted sales force such as ISOs 31 to reach merchants is common because acquiring banks 13 and or acquiring processors 32 generally do not have strong sales and operational experience in selling and or explaining the complex, complicated and multi-tiered payment network rules to merchants. Nor do acquiring banks 13 want to spend the time to qualify or underwrite the merchants to ensure that they meet the operational rules and risk assessment models of the payment network vendor 15 (V, MC, Amex, PayPal and the like). In exchange for this outsourced sales and marketing effort, the acquiring bank and or the acquiring processor can split some of their transaction fee revenue with outside parties who help them sell, reach or acquire these merchants. These outside or direct payment sales forces are the ISOs 31 who implement the “customer acquisition” services for these acquiring banks or payment processors, thus freeing up the acquiring bank or payment network operator to focus on other areas of servicing their customers.

Note that unlike the issuing banks 14 who build their own internal systems to directly market and sell to cardholders, acquiring banks 13 or processors may not provide a set of operating platform services for direct marketing and sales efforts to their customers (i.e. the ISOs 31 or merchants 12), and they may or may not provide statement processing, risk and compliance management, or general customer support and transaction monitoring. Typically, the transaction processor 32 or acquiring bank 13 or acquiring network 15 may provide some of these platform services which an ISO 31 may elect to utilize but from the point of view of the ISO 31 these have traditionally not been competitive with the state of the art systems deployed on the issuing side of the payments market. More importantly and commonly, some of the acquiring side platform services offered by processors have not been cost effective for ISOs 31 to manage their business, particularly their risk management tools to monitor their exposure to merchant risk. By not focusing on providing a set of platform services to the ISOs 31, the merchant acquirers or aggregators 32, acquiring banks have been able to focus their efforts on managing the bank deposit account relationship with the merchant 12 including the payment “net settlement” services while leaving the rest of the work to third parties such as the processors, aggregators and the ISOs. Thus, on the merchant acquiring side, the decision of who provides these services is left up to either the network switch operator and or payment processor 32 or to the ISO 31 to provide these important but missing platform components. The choice of how to implement and handle the various aspects of delivering these system components safely, effectively and more important profitably to any new merchant acquiring service offering is a fundamental business model decision that typically is left to the ISO 31 to solve.

As previously mentioned, most commonly the merchant 12 is marketed and sold to by a network of direct sales agents called Independent Sales or Service Organizations (ISOs). An ISO 31 may offer or quote hundreds of rates to a merchant, making the merchant's decision complex unless they are seeking a single specific price for a single type of transaction for a single payment method. Typically, the ISO 31 business model is delivered as a “bundled service offering” which represents the acquiring bank 13, the processor 32 and a set of service offerings per card network or payment process 15. The ISO 31 packages together a “bundle of merchant services” to make the sale to the merchant 12 easier and more convenient. A typical service bundle may include a hardware or software based “swipe” terminal device and or POS device, a merchant clearing and settlement account at an acquiring bank 13 to hold the “net” funds amount, and a set of business rules governing transaction risk along with a variety of “discount fee” structures set by both the processors 32, issuing banks 14 and card networks 15 that “wrap” together the costs of the various parties services and fees. This amount makes up the total amount of “discount” points, fees and or percentage the merchant agrees to pay in order to accept credit cards (or debit cards or ACH or other alternative payment forms) from their customers. Note that the discount fee may vary from merchant to merchant and or from transaction type to transaction type or by card type or by customer and the like. Also note that sometimes the ISOs 31 agree to a “buy rate” from the merchant acquiring bank 13 or processor 32 which they then markup or add their costs to and represent the total cost to the merchant. This total discount rate or sometimes known as a “buy rate” is then used to specify the service model quote for the transaction services that the merchant 12 buys from the ISO 31. Thus the existing delivery and management of merchant services is a complex, multi-tiered and highly specific business method that pushes the burden of managing merchants and overall business model risk down to the lowest level possible—e.g. typically down to the ISO 31, yet the ISO may have the least control over the risks of the payment transactions.

Traditionally ISOs 31 face many challenges when selling and explaining their services to merchants 12. These challenges come from the complexity of the acquiring payments business models, transaction processing and the risks involved in approving the processing of the payment flows. Primarily the issue for an ISO 31 comes from finding an easy way to define or quote a single “discount” rate or price for any of their services to a prospective or current customer. The difficulty comes from the need to combine the various components of the complex payment processing pricing schemes which may be composed of interchange rates, periodic dues or fees, network connectivity and processing fees, service assessments, equipment fees and access fees and the like. These rates or fees may be put forth by the various network system parties including acquiring banks 13, the processors 32 and the card or payment companies 15A such as Visa, Amex, Discover, MasterCard, or other alternative payment forms and the like. Note that even for a single network payment provider such as Visa, let alone the multiple payment networks the ISO may offer, these fees and components may vary across transaction volume “tiers” or “levels”, products, categories or merchant “types” and overall merchant risk profile. Thus, when ISOs 31 desire to sell to merchants 12 they may bundle or blend all of these fees into a single comprehensible pricing or cost model in order for the merchant to evaluate their service against competing ISOs, aggregators 32 or alternative payment networks 15.

Large volume, highly sophisticated Level 1-2 merchants have traditionally hired dedicated resources to understand, manage and even “negotiate” their interchange or discount rates as well as their transaction volumes and define their overall risks. The vast majority of merchants 12 are smaller Level 3 and Level 4 merchant operations who, while they face similar transaction processing complexity, lack the infrastructure to effectively manage this complexity. In particular, the Level 4 “mom and pop” merchants frequently find interchange pricing confusing and therefore they depend on the ISO 31 to sell and support them in utilizing payment services. Additionally, even smaller but more numerous are the millions of new ecommerce or “m-commerce” merchants or businesses who may use mobile digital devices (phone, PDA, tablet or the like) which allow these micro-merchants (e.g. Level 5) to accept a card or alternative payment. However, given the infrequent use of payment services by these level 5 “micro-merchants”, it has been seen that they, like level 4 merchants, have a strong aversion to paying both monthly minimum fees in addition to higher discount fees which have been traditionally offered to them under existing ISO 31 or acquiring 32 business model methods.

To simplify this complex sales process, ISOs 31 have traditionally priced merchant accounts on a three-level or tiered pricing plan consisting of a “qualified rate”, a “mid-qualified rate” and a “non-qualified” rate which is typically offered to their merchants. The ISO 31 marketing plans presented to their merchants typically discuss their tiered pricing schedules by quoting a rate “as low as” the qualified rate, then impose steep surcharges for transactions defined to belong to either the mid or the non qualified rate categories. Merchants 12, particularly level 4 and now level 5 merchants dislike this pricing scheme as they may have little or no experience with or an incomplete understanding of these network components and or they have little control over which transactions fall into mid and non-qualified rate tiers. Thus, many merchants 12 seek and desire more certainty or surety in the true or final cost of their merchant payment processing services, while ISOs 31 seek simplicity and low risk.

Traditionally ISO's 31 may provide all of the sales, marketing and first line support on the merchant or payee side of the payment model. Note that the risk management capabilities of these services can be seen to be lacking or inadequate when compared to similar support services provided by the issuing bank 14 for the card holder or payment maker (payor 11). Thus, a key differentiator for the ISO's 31 business methods and delivery models is determined by how well they provide customer sales and support as well as how they manage the level of merchant 12 and transaction risk that they take on, or become responsible for, under the processing and settlement services for one or more of the payment networks which they have offered to a merchant 12. Risks for ISOs 31 may come when they perform one of merchant qualification, risk assessment, compliance or security policy management and or underwriting tasks for the acquiring bank 13 or payment processor 32 or network 15. Commonly this evaluation or underwriting process is based on voluntarily data input provided by (or self-defined) the merchant 12 or from the original sales procedures agreed to by the merchant 12. Even existing third party business credit risk or scoring and evaluation services such as D&B type of reports may rely on merchant 12 self-reported data which may not accurately reflect the level of merchant risk or relate to the type of transaction processing that the ISO 31 is providing to the merchant. In addition, merchants may expose their payment acquiring partners to risks through their failure to properly account for, track and file the sales or use taxes collected during their sales activity for a period. Additionally, exposure to unknown risk is brought into the ISO 31 business when they take on the risk of any transaction amount being charged back to the merchant through the processor and acquiring bank by notification or dispute by the cardholder 11 or issuing bank 14. A primary risk from charge-backs is that the merchant will not have sufficient funds to cover a future charge-back as well as the risk of a merchant going out of business leaving the ISO 31 liable for their transactions. In addition there is a risk to the ISO of general merchant fraud or deception during underwriting. Thus, ISO's may unknowingly take on more risk when their role extends beyond the sales process.

While general or historical charge-back ratios may be widely known to the industry and certain types of businesses are known to be prohibited from being set up to accept payments by the existing payment network providers, there are no specific industry guidelines for risk management that an ISO 31 may follow. The only thing that the acquiring banks 13 care about is that someone (merchant or ISO) covers any losses which they may incur due to actions or inactions put forth by unscrupulous merchants, faulty or misrepresented products and or purely fraudulent transactions. For example, if a furniture store goes out of business, all the cardholders who paid with a Visa card for a sofa to be delivered will probably contact their issuing bank and ask for a chargeback on their payment for the sofa for non receipt of merchandise. Since the furniture store is out of business they will most likely not be able to pay back the cardholder, so therefore the ISO 31 is the next party targeted to be responsible for reimbursing these funds. If the ISO is not able to handle the loss, the acquiring bank 13 will most likely pay the balance due. Typically the payment technology providers such as gateways, switches or terminal providers are not part of the risk equation, as they simply originate and or pass along the data that makes up a transaction.

To define a traditional processing solution, a merchant 12 is approved and established for a merchant account. The merchant accepts a payment form or method from a payor 11. The payment data is processed for an authorization approval (it may also be declined). If the authorization is received from the issuing bank then the transaction can be settled for payment. For a $100 transaction, it may take just seconds to authorize and a day to settle funds to the merchant. Yet the chargeback risk of dispute remains for months. The type of business, in particularly future delivery businesses, presents a higher risk profile. The size of the transaction, in this case $100, is an amount that a cardholder may not typically overlook. If the cardholder does dispute the transaction, depending on the reason for the charge-back, the funds may be immediately withdrawn from the merchant's bank account and returned to the cardholder's issuing bank 14. The risk accumulates when cardholders are disputing transactions because of services not rendered; the merchant 12 declares bankruptcy or stolen cards were processed for funding. In these situations, funds are pulled back from the merchant's deposit account but when there are no funds available then the liability falls to the ISO. Thus, ISO 31 exposure to risk is one of the primary causes of ISO business failure.

A key aspect of the delivery of the ISO model in the payments market is the identification of which types of risk are being taken on by ISOs 31 when they sell or agree to service a merchant 12. Generally, there are two types of ISOs 31: those that are not liable (zero liability) for any merchant transactions and who therefore accept a lower cut of the discount fee and those ISOs that will take on 100% (full liability) of the risk of every transaction originated by the merchant 12. One reason to be a 100% liable ISO is that these types of ISOs gain a higher percentage share of the discount or transaction fees. Therefore ISOs that take on 100% liability for their portfolio of merchants gain higher revenue rates but also are required to provide their own systems for underwriting control, merchant and transaction risk evaluation along with customer support of the merchant 12. Of course, electing to work under a 100% risk based model means that a successful 100% liable ISO should have higher costs due to additional people, procedures and transaction monitoring systems. They may also be required to pay for the management and monitoring of these more complex systems while also being liable for higher merchant or business risk—a practice that few ISOs are prepared to fund or underwrite given the costs of preferred systems. Finally, 100% liable ISOs may be required to keep a reserve account with the processor 32 and or acquiring bank 13 to cover merchant 12 and transaction risks and this reserve may grow due to increased transaction volume and signing more merchants up for their services. Thus a successful 100% liable ISO has a complex problem facing them as they grow their business and yet they may not have access to a set of platform services to guide them.

A critical challenge ISOs 31 face is managing the risk of merchant operations. Additional operating risks that merchant acquiring service providers (primarily ISOs) may be exposed to include the fact that merchants may go out of business and or not deliver goods or services that were paid for by their customers—this is known as “future delivery” risk. Another major risk for service providers is inadvertently establishing a merchant account for a truly fraudulent business (one which never intends to be legitimate or one setup to steal funds from unsuspecting customers). ISO risk accumulates based on the amount of sales processed and settled for funding because merchants are typically funded on the next business day for any card transactions they submit while cardholders and issuing banks may typically retain chargeback or dispute rights for many days, weeks or even months following the original transaction date. The type of business, type of product, sales volume and merchant credit rating all may play a role in defining the risk profile and therefore approval profile or level of a merchant account. Clearly, the “100% liable” ISO has to maintain constant vigilance over their merchant portfolio or face huge losses which could put them out of business. The “no risk” based ISO does not bear these liabilities, but they also may not approve merchant accounts and they may have no control on the timing of getting accounts approved and set up. Also, because of these limitations, the “no risk” ISOs have higher “buy rates” which translates into being less competitive in the market to win new business. Thus, the “100% liable” ISO can take on or “write” more accounts and make greater margins but only to the extent that they manage risk and prevent losses from charge-backs or non-payment of fees or taxes or fines or the costs of non-compliance or the costs of data or customer privacy breaches.

The ISOs who choose the 100% liable transaction risk model may therefore design and implement their own systems and methods to identify, quantify and monitor overall merchant risk at signup as well as on an ongoing basis once the merchant is enabled for payment processing. In addition to initial risk assessment, a 100% liable ISO should have a way to monitor every transaction or be willing to be liable for the complete set of purchase charge-backs attributed by issuing banks 14, the card or payment networks 15, along with courts and other parties who may authorize or issue these charge-backs to the merchant 12 (typically due to fraud, stolen cards or identities, customer dissatisfaction, dispute and the like). Thus, while they may often be the least capable or equipped to do so, any 100% liable ISO who desires to sell a new bundle of services or sell to a new type or “tier” of customer needs to solve these platform risk management decisions in order to effectively offer a better set of payment processing services to these new markets. As can be seen by those skilled in the art, the combination of optional, neglected or missing platform services on the acquiring side along with expensive transaction monitoring system requirements for risk management along with pressure from competitive market forces by other ISOs have prevented the creation of new merchant acquiring service offerings. What is needed is a way for an ISO 31 or aggregator 32 or any merchant acquiring system to offer new payment processing services to markets under a pre-identified or “managed risk” model with an easy to understand competitive price basis, typically without high costs or fixed monthly fees.

Managing merchant risks starts with an underwriting process that includes completing merchant application paperwork, pulling credit reports, and conducting a site survey along with other activities or requirements required by the processor 32, the acquiring bank 13 or the payment network provider 15. Traditionally, merchants 12 open a merchant account and contractually agree to pay a set of discount rates and fees for accepting credit and debit cards or other payment forms in which charges occur as transactions are processed or they are billed in arrears on a billing statement after transactions have been processed. Complex pricing must be explained to merchants during the sales process, these pricing models must be contractually agreed to and billing statements must reflect this complex billing or fee structure. Merchants have a difficult time understanding the rates and fees and total bottom line expense for card acceptance. Merchant account providers also take the risk of setting up fraudulent merchants or merchants that become victims of fraud. Site surveys and other underwriting guidelines are performed to mitigate the risk of establishing a fraudulent merchant account. Once a merchant account has been activated, an extensive risk monitoring system utilizing both technology and manpower must closely watch merchant activity for unusual activity such as higher sales volume or transaction sizes than the merchant was originally approved through underwriting.

Factors which influence the level of merchant risk include the type of business (for example by SIC code), the type of goods or services offered, projected sales volumes and ticket size—all of these data points are initially volunteered or provided by the merchant 12 to the ISO 31 as either estimates or guesses and or promises, yet they are critical in determining the potential risk exposure to the ISO. Once the merchant account is live, traditional monitoring methods may be used by processors or payment networks to monitor merchant activity or transaction patterns on a periodic basis or “after the fact” basis, alerting a risk manager to take action to hold funds and/or suspend processing by turning off the ability for the terminal, POS, virtual terminal or ecommerce gateway to process further payments. These monitoring activities typically occur after transaction processing and may allow hundreds or thousands of transactions to occur or be approved before the risk monitoring trigger point is “hit” or a determination to cut off services is made. Additionally, post sale customer dissatisfaction with the merchant's goods or services may occur days if not weeks after delivery which may trigger a customer call to their issuing bank or payment network provider to complain. These customer complaints then trigger a process which may reverse the merchant funding of these purchase amounts from the issuing bank 14 to the acquiring bank 13 or similar process for alternative payment network providers. The acquiring bank 13 then looks to their customer (merchant and or ISO) to be made whole (or repaid) for the funds which were credited back to the issuing bank 14 and ultimately their customer. Thus, the ISO 31 may be liable for ongoing transaction risk beyond the scope of their direct control and therefore they must be willing to cover (or eat) the losses or require the merchant to utilize a funding “reserve” amount to cover future, unforeseen disputed or reversed transactions. ISO's traditionally find it difficult to sell merchants on keeping large “reserve” amounts and thus 100% liable ISOs may carry a great amount of risk for every merchant they sell and support with payment services or for supporting merchants without reserve accounts.

Thus what is needed and desired by the market is a way for ISOs 31 who wish to take on 100% liability for merchant processing payment services is the creation of a new system and method to sell, profile, evaluate, “onboard”, as well as monitor the ongoing operation of the millions of level 4 and level 5 merchants 12. These small or unsophisticated merchants could utilize payment services but who, for various reasons, either do not qualify for an account due to underwriting guidelines and or they find the current service offerings either dissatisfying, too expensive, cumbersome, or generally inconvenient. Many of these merchants would purchase merchant services if the entire offering could be packaged and delivered as a simple one (1) time purchase decision with well defined rules, boundaries and or conditions—that is, using a “prepaid” services model. In fact, using a pre-packaged merchant acquiring sales business system and method solution would enable these merchants to purchase bundles or multiple discreet units of services with each unit providing a set of services with agreeable terms and conditions.

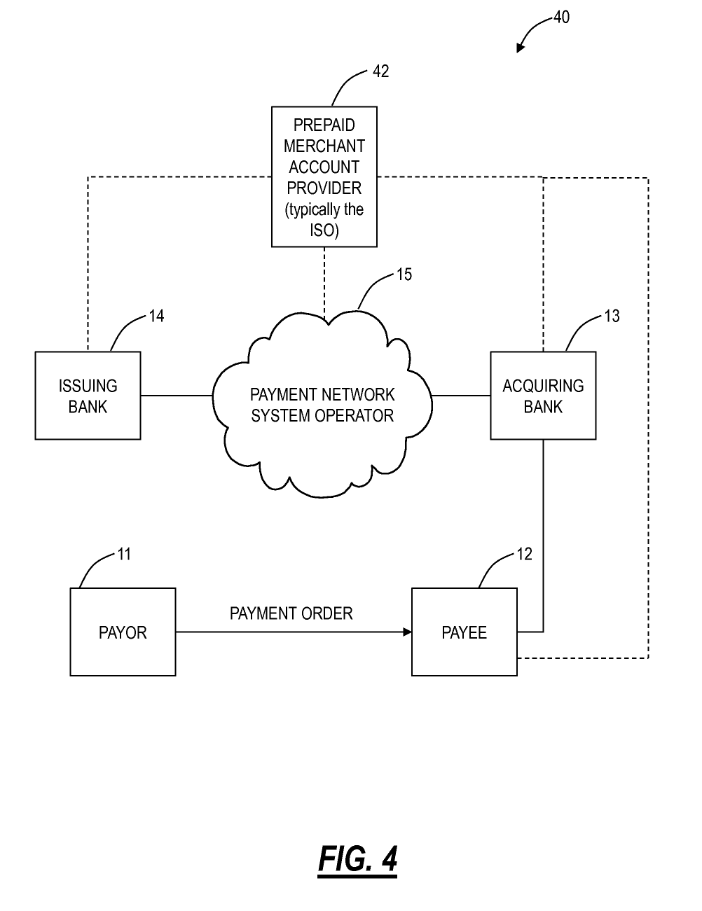

Referring to FIG. 4, in an exemplary embodiment, a diagram illustrates a network 40 for payments based on the electronic payment processing network 10. A preferred embodiment of the invention is to solve these common ISO 31 business method delivery challenges by the creation of the Prepaid Merchant Account (PPMA) 42 business system and method which is sold and operated by the ISO or acquirer. The Prepaid Merchant Account 42 would allow a merchant 12 to purchase payment or transaction processing services in advance and for a set fee for a set amount of purchase transactions and or set amount of time and other units or defined business model measurements and the like. While the vast majority of potential merchant accounts process only a few hundred or a few thousand dollars in payments a month, these merchants 12 commonly desire to know ahead of time what these transactions will cost them. The new mobile, or micro-merchants or seasonal merchants (i.e. Level 5 merchants) and the like are an additional segment of an estimated 15 million businesses who may not be utilizing the payment services provided by ISOs today. For these businesses a simplified PPMA 42 billing structure would be easier for both the ISO to explain and for the merchants 12 to understand than either the existing or traditional tiered interchange pricing methods commonly offered today. Currently, a simple, yet complete pre-paid, fixed cost and or fixed quantity of merchant acquiring or transaction processing services is not known to be offered to the market by any of the parties participating in the “5 party” model. Today, if one performs an Internet search for “Prepaid Merchant Services” what is returned is a search result set listing ISOs and or processors and banks that offer “prepaid cards” or payment forms with stored value of one form or another. Another example of the current absence of PPMA 42 services is shown by displays, events and information presented at the Electronic Transactions Association (ETA) annual conference in May 2011 where most innovations or state of the art solutions offered to the ISO or merchant acquiring market are announced or launched and yet no one was offering PPMA services, let alone explaining the need for such a service. Thus those who are skilled in the art will recognize that there currently is no PPMA model that is known to be available, offered or being contemplated to be offered to merchants today. It should be understood that this is not unusual or unreasonable as the large (and often well funded or managed) acquiring banks or processors are able to “self-insure” or regulate their own merchant risk and therefore they may have no need for a simplified sales model or a method to reduce risk and lower system management and monitoring overhead. Therefore the logical and preferred party to create or utilize a PPMA 42 system could be the 100% liable ISO. What is therefore needed is the creation and operation of a new “sixth” (6^{th}) party within the payment network 10 model in order to facilitate and deliver the required features and services of this new prepaid merchant acquiring payment product across various services and markets or to various types of merchants or business.

It is the purpose and scope of this invention to remedy the current market deficiency by defining and delivering such a model at various points including the most logical and operationally efficient point within the merchant acquiring services delivery model—operating at the level performed and provided by the 100% risk enabled ISO. However, it should be noted that the PPMA 42 system and method may also be enabled by the POS or gateway transaction service vendor, or the processor network 15 and/or the acquiring bank 13 (or a party who performs some and/or all of these functions). Any party who operates in such a new, novel and unique manner therefore becomes a new “6^{th} party” in the traditional payment processing market model or a new origination party or point for any type of transaction processing services. This new party 42 becomes the best and most likely entity to operationally and cost effectively go after (e.g. sell, service and support) the broadest or deepest set of the millions of level 4 and new level 5 merchants. Most likely, this service will be performed by the 100% risk enabled ISO and it may be this new 6^{th} party 42 who is most able to effectively capture and deliver these customers into the payments and transaction processing marketplace as enabled by the PPMA 42 system and method.

Note that this new payment system and method service model offering is primarily targeted at level 4 and 5 type merchants who desire to purchase a simplified payment transaction service model for which they can easily budget and understand. These PPMA payment services however, should not be confused with the merchant accepting “prepaid” or “stored value” cards and the like where the payor 11 makes a payment for the merchant's 12 goods or services using a payment service which transfers funds from a payor's 11 previously funded account (i.e. the payors payment was prepaid or stored before the sale was made) or where the payor 11 may have pre-arranged for a line of credit or insurance against payment default or guaranteed payments and the like. These payor 11 oriented payment methods, practices or models do not mitigate the bad business practices or risks on the merchant 12 acquiring side which may include merchant default, non-payment, fraud, bankruptcy, non-payment of processing fees or the like. What is needed by the 100% liable ISO 31, is a way to offer merchants 12 a well defined fee for merchant payment processing services without exposure or risk to the ISO for losses due to merchant operations as well as protect them against the loss of fee income and or limiting their exposure to a merchant for a fixed dollar value of transactions or fixed number of transaction units or to a fixed time period or any and all business model rules or conditions. Typically, ISOs may take losses due to non-payment of fees by the merchant which are caused by various payment processing business risk conditions such as bankruptcy, fraud, or illegal activity by the payor 11 or merchant 12 or other element within the processing network. By having the merchant 12 pre-pay their payment processing fees to the ISO 31 or other PPMA 42 provider, the PPMA protects against the loss of not receiving their portion of the transaction fees while also potentially limiting the exposure of the PPMA provider to a total dollar value of sales transactions processed for or on behalf of a specific merchant under a specific duration of time or other term or condition.

Currently, without a PPMA 42 service, ISOs may have to manually monitor their transaction risk, or they may purchase or lease an existing risk monitoring system that could generate lists of transactions from merchants to review after they have been processed. These lists are based on risk parameters that may include statistics or values for sales volumes, transaction sizes, and amount of “key entered” sales versus “swipe card” sales and the like. Today these existing systems typically work by highlighting any large sales or large deposits which are out of the norm for a merchant. A risk manager then makes a decision to either hold deposits or allow the transactions to be funded into the merchant's bank account. If funds are held, the risk manager may contact the merchant to inquire for more information and details about the specific transaction. The payor, customer or cardholder may also be contacted to inquire about their knowledge of the specific transaction. This is an expensive, time consuming and labor intensive process which most ISOs are not equipped to utilize in the everyday course of their business. The PPMA 42 system provides a better way to achieve similar results using an automatic and pre-packaged way to effectively deliver the required business systems and methods into the market via upfront transaction risk evaluation and enforcement before any payment transaction is approved, not after.

While recent court rulings or US regulations such as the Dodd-Frank bill and Durbin amendment or other laws may have the ability to change the allocation of fees or rates offered by acquiring vendors 13/32 and therefore ISOs 31, none of these changes may eliminate the need for the PPMA 42 business method and system. Currently some of the proposed implementation of some of these rule changes may be postponed or modified by various court challenges, particularly the “Durbin Amendment” and its implementation of new fixed fees by new rules which will be set by the Federal Reserve. Regardless of any proposed electronic payment or processing system rule changes that may be mandated or required by laws or compliance regulations and the like, there is still an obvious need for a new payment processing system and business method such as the PPMA model that reduces risk and improves profitability. It should be evident to those skilled in the art that the 100% liable ISO 31 or other acquiring agent or entity has a need to minimize risk and losses while selling merchant payment services. This is especially needed for the new types of mobile or micro merchants and the like who operate and or provide their services under new market conditions. This is particularly true for ISOs who target their services at merchants who may have infrequent sales or low sales volume or other conditions outside of the traditional tier 1-3 models yet they still desire merchant payment services.

The PPMA 42 system and method can be seen to provide many benefits to the provider including a better “sales method” and an automated “risk management method” as well as an “operational business method” among other concepts as it helps simplify the sales process, mitigate or reduce risk, while simplifying the operating conditions for managing and running a payments acquiring and processing business. Thus it is different from previous attempts at either sales models, risk management models or operational models. In particular, the PPMA 42 is not a prepaid card or consumer payment account method as the focus of that model is on the payor, while the PPMA 42 provides a system and method for the processing of a transaction or payment for a payee or merchant 12 before it is handed off to the processor 32 or acquiring bank 13.

An exemplary definition of this invention is a Prepaid Merchant Account (PPMA) 42 service which is a system and method for businesses and merchants to prepay for payment or processing services such as credit or debit card, prepaid or stored value card, rebates, coupons or gift cards, loyalty or rewards point processing, along with check or ACH transaction processing or any type or form of alternative payment or value processing service. The Prepaid Merchant Account 42 services system and method is a solution that allows an ISO 31 or provider to be able to expand their sales or operational coverage of or support to merchants, particularly for the many level 4 and new level 5 “micro-merchants”, with reduced operational risks and at lower costs and or with higher profits. This easier, more flexible sales and operating system and method offers providers a way to reduce merchant 12 and or transaction risk caused by exposure to the losses caused by charge-backs or fraud or the inherent risks in accepting and processing payments for third parties. Under the PPMA 42, a provider may implement the solution as a system and or method of packaging, marketing, selling, provisioning or enabling, supporting and processing payment or value transactions with the PPMA provider becoming a new 6^{th} party 42 within the traditional “5 party” network payment model or as a new originating party or network origination point in other transaction processing systems such as loyalty, rewards, rebate, coupon or invoice processing. That is, the PPMA 42 provider may be inserted between the merchant 12 and the intended processor 32, acquiring bank 13 or network 15 due to the fact that the PPMA 42 provider now may be viewed as the originator of prepaid transactions operating under pre-agreed to rules with the merchant 12. The PPMA 42 model is different from existing aggregator or gateway processing models in that unlike these other models, the PPMA 42 provider has agreed to take on the risk of the transactions up to the specified and prepaid limit under specified rules or conditions of the contract as well as having their fees or costs covered by upfront, prepayments before processing starts among other business model benefits. Additional value may be provided or accrued to the merchant 12 under this model and the PPMA 42 provider may gain additional systemic advantages or leverage by operating this way. For example, the PPMA 42 system and method may be enabled through “App Store” sales and delivery models, enabling Internet or mobile users to purchase prepaid transaction processing services which may enable dynamic payment processing on their PC, phone or mobile device in real time or on the fly, as they are needed by the merchant or casual user—all without extensive underwriting or processing delays.

In an exemplary embodiment, the PPMA 42 provider is a computer system, server, cluster of servers, etc. that is communicatively coupled to the payee/merchant 12 and the payment network system operator 15, aggregator 32, or other network party. Optionally, the PPMA 42 provider is communicatively coupled to the acquiring bank 13 and/or the issuing bank 14. That is, the PPMA 42 provider can communicate on a network (e.g., the Internet, a Virtual Private Network (VPN), etc.) to interact with the various entities 12, 13, 14, 15, 32 for the PPMA systems and methods described herein. This new processing origination model allows the PPMA 42 provider, as a new 6^{th} party, to inspect transactions before they are authorized, enabled or further processed by the payment or settlement network.

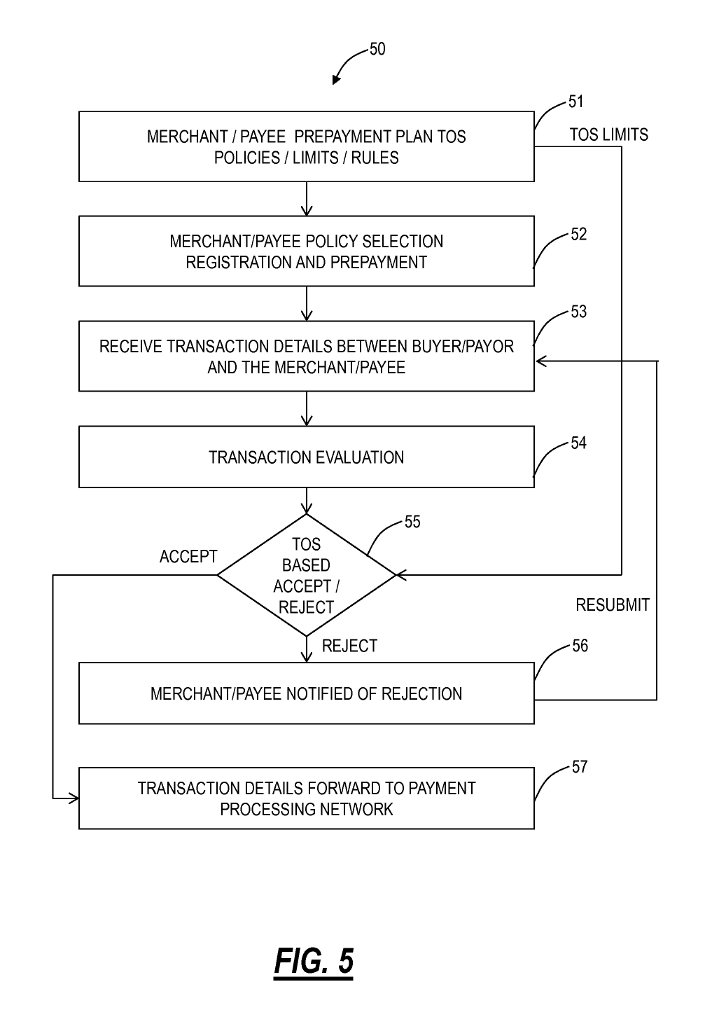

Referring to FIG. 5, in an exemplary embodiment, a flowchart illustrates a PPMA method 50. The method 50 is a computer implemented method over computing devices on a network. First, the method 50 involves the PPMA provider 42 creating and specifying what types of PPMA policy limits will be made available—policy limits, rules or conditions may be set on what type of transaction volume, size or levels are sent, or on the total dollar amount or other financial conditions, or on the length of processing time or any other limits and conditions will be enforced under the purchase of the PPMA service (step 51). Second, the method 50 includes the merchant/payee 12 selecting a plan, registering and then providing prepayment to a PPMA 42 system/provider (step 52). In its simplest form, a PPMA transaction processing system and method enables a merchant to pre-pay for the ability to send to the PPMA provider a defined set of payment or processing transactions on behalf of their customers under previously agreed to limits or conditions. The PPMA system and method may include other offers such as allowing the merchant to pay an additional fee as a pre-paid insurance premium which could cover the risks of future merchant transactions or operational actions or non-actions or general business failure. Note that many additional services, offers, options or other flexible business model rules may be included in a PPMA model such as offering discounts for frequent or continuous usage, or a discount or reward points if the merchant hits defined volume, usage or processing levels consistently or if they achieve targeted quality levels such as no charge-backs, or if the merchant refers new customers to the provider for new business, or to use settled funds to make prepaid contributions to merchant reserve accounts when or as deemed to be useful or necessary by the PPMA provider or merchant, or by offering discounts or promotions for compliance within the rules, and or expanded terms or service when certain conditions are met by the merchant and so forth.

The method 50 includes the PPMA 42 system/provider receiving transaction details between the buyer/payor 11 and the merchant/payee 12 (step 53). The PPMA system and method may require the merchant to provide and or the PPMA provider to receive processing requests with either standard data or transaction details or they may require new or expanded transaction data or details. The method 50 enables the PPMA 42 provider to evaluate the transaction request against the PPMA terms of service rather than the payment network or processing network terms and conditions. Thus the PPMA may receive a valid PPMA transaction (i.e. one which meets all existing PPMA terms, conditions and current operating levels, timing or positions) over to a processor, gateway, switch or network to seek authorization or further processing for the transaction, but this transaction may still be subject to rejection or failure to be authorized by the network provider for various reasons outside of the PPMA terms. Normal or traditional payment transaction processing rejection may be caused by a variety of reasons including the payor exceeding their credit limit, non-qualification of transaction type or details, invalid PIN number and the like triggering rejection or a variety of other conditions controlled by the payment issuer such as the request being matched against a closed account or an account suspected of fraud and the like. All of these transaction rejection conditions occur outside of the PPMA limits and may have no effect on the originating merchant's status under their PPMA contract, although the PPMA provider may also track these rejections as yet another indication or metric of merchant risk including the quality of their submitted transactions or historic patterns.

The method 50 includes evaluation of the transaction (step 54). The PPMA provider may inspect the transaction details and calculate or evaluate current operating conditions, then they may evaluate the impact of the transaction against the existing PPMA account settings and status as well as the rules agreed to between the PPMA provider and the specified, identified or responsible party for the transaction, and then make a determination if the transaction fits within the approved scope of the PPMA agreement rules or conditions. Note that the evaluation and determination of the transaction's eligibility under the PPMA process has nothing to do with the merchant's status at the acquiring entity (typically the bank) or their customer's status with the issuing bank or the status of their form of payment—these are conditions that may be checked and evaluated by the payment or transaction gateway, processor, switch or network operator and or issuing bank. If the transaction falls outside the PPMA terms or agreement (step 55), the merchant is notified that the transaction is rejected and the merchant may have an automated or manual response to the rejection notification (step 56). For example, the system may provide merchants with the opportunity to respond to the rejection or correct the transaction by “resubmitting” the transaction using one of various automated or manual methods including reducing the value, size or amount of the transaction items, or they may pay an additional fee for “instant on” processing or enablement, or they may purchase more PPMA contracts or ask the PPMA provider to use an alternative payment processing method among other flexible implementation and processing rules offered by the PPMA. The merchant may also choose to accept the rejection notification and end the transaction at step 56 if there is no other alternative for them to choose and the merchant may notify the payor that the transaction could not go through. If the transaction is accepted by the PPMA provider (step 55), the transactions details are forwarded on to the responsible payment processor, network, bank or provider under the typical, standard or existing processing methods known at the time (step 57). The PPMA system and method may also include at step 57 the ability of the PPMA provider to perform transaction or message re-formatting as needed to complete a transaction, and or make corrections, translations or conversions and or fix ups to occur before forwarding the transaction for payment approval or further processing and clearing. Additionally, other business model, payment forms or functions and or technical conversions or processes may be applied as needed to make the transaction request work along the specified processing or settlement route. Finally, the PPMA provider may track the actual results, responses and or costs beyond the PPMA provider's system and these subsequent network transaction processing outcomes may be monitored or evaluated versus the pre-paid rules or committed to services or levels in order to create new or modify existing PPMA contract conditions, limits or terms to ensure the future profitability or suitability of service for new or existing clients. Thus the overall risk level of any merchant transaction under this system is greatly reduced by both the prepayment of fees as well as the automated transaction inspection using the purchased policy settings or limits using the type of PPMA purchased by the merchant before any transaction is forwarded on to the traditional payment processor or network.

A key advantage of the PPMA system and method is the sales and operational simplicity or flexibility it provides to the PPMA provider while also providing them more control over their overall operations and exposure to specific transaction risk (e.g. from type, amount, item and the like) and or to the risk of the merchant making the request as well as to all types of transactions generated across all of their PPMA contracted merchants. One advantage of the PPMA invention is the ability to offer policies or plans with mixed or multi-use bundles of processing services with discounts—for example, a bundle may be offered for each payment type, or one that offered 50% debit card and 50% credit card processing services could be offered at a reduced rate as compared to a 100% credit card processing service. The PPMA provider may offer or enforce various payment processing ratios or percentages within different PPMA account sales offerings as a way to enable merchants to select the best fit of processing services for their business. An additional advantage to the PPMA provider is the possible elimination of or reduction to the size of a merchant's reserve account amounts under certain bundles or offerings. The PPMA provider may also benefit from a simplified risk monitoring and management system with reduced costs and reduced burden on operating personnel. Optionally, the PPMA system and method may provide more options or flexibility in integrating with or dealing with other merchant operational issues such as sales tax collection or filing systems, coupon services, escrow services, accounts payable (AP) or accounts receivable (AR) or other accounting efforts as well as other business functions such as inventory tracking and management, customer loyalty or rewards tracking and the like that the merchant may wish to offload onto the PPMA provider. Other advantages of the PPMA system and method may be derived from benefits that are similar or identical to the well known benefits of prepaid card or stored value card business models such as the provider retaining any unused balance or “breakage” from unused processing services. Finally, better forecasting of future operating and processing needs may be delivered to the PPMA provider through visibility gained by having merchant contracts specified in fixed terms or units as well as by tracking the proposed or budgeted capacities or risk levels versus actual transactions, costs, approval rates, and risks among other statistics or variables tracked, measured, rated or evaluated by the PPMA provider.

A key element of this system and method is that it enables the PPMA provider to make a determination of or set a budget for or limit on their risk exposure before they accept responsibility for the merchant in general (i.e. before agreeing to sign up the merchant), or before they accept responsibility for a specific set of or type of transactions for which they will process for approval and settlement by the payment network provider. This flexibility and control comes from the rules and conditions defined by the PPMA terms of service (TOS) and contract. Once the PPMA contract or TOS is defined, the PPMA provider's workload is simplified by having the ability to explain their services as pre-packaged sets of services with defined pricing models and terms to merchants and when these are agreeable to the merchant, the PPMA contract binds the merchant to future transaction processing restrictions or limits defined by the contract or TOS. Examples of such PPMA rules, limits, or conditions may include processing sales up to a total amount or a fixed dollar amount of sales or as a total amount generated during a single time period, or up to a fixed number of transactions, or transactions of a pre-set dollar value (or above or below a dollar value or ticket size or number of line items and the like), or only enabled to take transactions on weekends, or between a set period of time such as between October and January or between 6 pm and midnight, or for a single day or for the duration of an event or combinations thereof. Additional examples of PPMA limits or rules include providing transactions for a single merchant product or SKU or for a merchant defined range of products, or for products at or below a defined price, or from payments from a specified set of customers or for a specified customer type or channel or for a specific form or type of payment or payment route. The ability to set rules or limits around transaction types, volumes or amounts allows the PPM provider to segment merchants into new categories or groups in manner similar to insurance company risk models. Another element of the PPMA system is its application to sales tax collection procedures, requirements and strategies as a way to either enable or disable and or enforce tax collections under the PPMA contract rules or conditions or include other escrow type services or withholding services and the like. Finally, PPMA services may be provided for transactions enabled only from a specific device (such as a website or set of URLs, or for mobile phone, PDA or tablet devices or sets of devices and the like) or originate within from a defined set of TCP/IP addresses, geographic zone or area (such as inside the US or within a single state or city and or zip code), or outside a defined region and the like. All of these limits or conditions and many more or similar business rules, terms or conditions may be defined by the PPMA terms of service and contract and may be utilized by PPMA systems and methods to limit or guide service implementations.

Under the PPMA system and method, the prepaid amount includes paying upfront for the provider's service fees (e.g. some costs, all costs or costs plus profits), ensuring for example that the ISO can afford to process future transactions on behalf of the PPMA customer. The prepaid amount may include, or wrap-up, a set of upfront fees including transaction processing fees, discount points or fees, network or connectivity access fees, equipment rental fees, as well as insurance or risk premium fees (per merchant, per SKU or item and or both) when the providers systems and methods or underwriting guidelines suggest that they be included. Additionally, a PPMA model may include pre-reserved funds for future charge-backs or other business model fees and the like. Next or optionally, a merchant may choose to pre-pay fees for “instant-on” services (which ensure that if, in the future, any of their transactions exceeds the PPMA defined limits, it will be processed up to some new limit versus being rejected as exceeding the original PPMA limit), or it may include an option to upgrade to a new service level if sales or transactions exceed the pre-agreed to levels or limits and the like. Optionally, the PPMA system and method may enable a PPMA provider to auto-continue or rollover service to a merchant on a “at will” basis if the prior period's service operated as agreed to or within a range or below a limit or other rule or condition. Finally, the PPMA system and method may also enable a merchant to downgrade their transaction service level if their sales are not up to forecasted or projected limits or volumes, saving them future fees and or auto-renewing at reduced PPMA levels which are priced accordingly. Merchants may have the option to “opt-out” of automatic features by not signing or agreeing to new terms, or they may reject auto-generated new PPMA terms of service and cancel services.

Additional PPMA system features are that all prepaid amounts are confirmed as being settled, cleared and paid to the PPMA provider prior to any transactions occurring or originating under the agreement. Negotiation and delivery of the PPMA prepaid payment amount under this system may occur by the merchant agreeing to “auto-drafts” of PPMA prices using secure and or reliable payment processes such as cash, check, prepaid cards, debit cards or ACH direct debits against the merchant's bank account (not necessarily the same as the merchant's settlement account) or other payment forms mutually agreed to by both parties and which are enabled and effective before PPMA processing services start. Prepayment ensures that the PPMA provider may only be exposed to specific transaction charge-back risks up to the pre-agreed to amounts. Thus providers can track, monitor and evaluate their overall transaction risk exposure using a variety of business model risk measurements or units such as dollars, time or volume.

An additional advantage of the PPMA model is the ability to “tie” or integrate the Merchant's PPMA ID or prepaid processing codes to a barcode on an item for easy or express purchasing. Examples include embedding the product/item or services' SKU number along with the Merchant ID and or other PPMA TOS, rules or metadata controls into the product or item's barcode so that scanning the item or package passes along required information on how to process the transaction. When the POS or payment gateway or other processing device decodes the barcode, the additional PPMA information is available to automate the exact path or process that the PPMA transaction should follow to conform to the merchant's desired process. Additionally, the PPMA “contract” or service could be itself packaged as a barcode on a card so that “Merchant Services” processing activity could be conveniently sold in retail stores via a plastic card or paper form displayed on the store shelf or at the POS checkout lane or other appropriate location. Exiting but not identical types of packaged merchant services includes the merchant processing accounts sold with swipe terminals at retailers such as CostCo that include bundled card processing agreements, however under the PPMA this would include the additional fee of prepaying for the processing services. Another example of utilizing this service is at hotels, clubs, resorts, events or other venues or locations where prepaid cards, or mobile apps, and the like could be made available to guests, members, attendees and the like to purchase items on location with the private card associated with the event (such as a hotel room key, membership card, event ticket and the like) which includes fees to purchase items that the merchant would need to pass along. Finally the idea of embedding or tying PPMA services to barcodes works for 1D or 2D barcodes such as the PDF417 standard as well as the QRcodes used on mobile devices to pay for items at checkout. The merchants may generate mobile QR codes that embed the merchant ID to inform the processor whom to charge for the item being scanned using the payment method selected by the mobile device owner, user or customer. The PPMA service provider could utilize this information to route the transaction appropriately, bill the customer and credit the mobile merchant all on the fly from a dynamic POS transaction. The routing of the transaction can take the ISO message generated by the scan to create the appropriate standard ISO transaction message or utilize the BIN number or other unique PPMA ID to identify who the merchant is and how to process the transaction using the channels defined by the PPMA contract or policy. Thus the PPMA model can be extended into the physical world through price tags, plastic or paper cards, tickets, mobile phone apps or even virtual terminal “icons” that represent the either the item plus the PPMA contract or just the PPMA contract and processing services covered by the identified TOS policy or contract.

Utilizing a PPMA offers advantages to both the merchant and the PPMA account provider which is typically the ISO. The PPMA model eliminates the risk to the PPMA account provider for nonpayment of their processing fees while also limiting the total risk of provided services to a known transaction size or scope as measured by transaction volume, dollar amount, time of origination or other units or limits and the like agreed to under the terms of service. In addition, an additional benefit to the PPMA provider is that the merchant will be able to predetermine what their total processing expenses will be and their customer may enjoy a simple and easy to understand pricing model making the job of the PPMA sales agent easier. The PPMA account provider may also gain a competitive advantage in the merchant acquiring marketplace by reducing or eliminating the complexity of quoting multiple rates and fees and enjoy reduced financial risk by predetermining their known financial loss exposure by setting a predetermined cap on processing volume, types and levels and by collecting fee income upfront before transaction processing service occurs. Finally, the PPMA provider may include other business services or transaction processing features along with or in addition to payments processing, allowing for new “bundles” of services to operate on similar terms, limits or conditions as the payment, for example a coupon discount applied to a payment.

The contract and terms of service (TOS) for a Prepaid Merchant Account (PPMA) would govern the type of, amount of, and duration of the processing services sold to and purchased by the merchant. Small, mobile, or seasonal merchants and the like would all benefit with prepaid pricing to avoid the cost of recurring monthly statements, recurring maintenance and minimum fees during periods of infrequent merchant operation or sales activity. The PPMA model would allow level 4 and level 5 merchants to purchase and accept merchant acquiring services by enabling them to more easily understand, budget for and afford the costs of payment acceptance methods along with simplifying the merchant transaction processing rules and submission process from their perspective. Thus a PPMA benefits both the ISO and the merchant as it simplifies both the sales process and the merchant's purchase and operational experience.

Operating a Prepaid Merchant Agreement service program may lower the ongoing cost of risk monitoring for the provider. Risk management is improved with the ability to set dynamic parameters for upgrading, renewing, topping off and or reloading the PPMA with additional future processing privileges. Key components which may be utilized by this invention include the following: a well defined set of merchant pricing plans (establish based on true or current processing costs, competition, industry risk, gross and net sales volume levels, transaction size, contract terms, type of product or service, age or type of business—new or existing business, and the like), a direct billing method for pre-payment of fees (e.g. a way to directly draft or charge the merchant's business checking account for fees at the start of the contract), a processing method to inspect, measure, monitor and manage transaction activity to prevent a merchant from exceeding prepaid volume, time or dollar limits or other contract terms or measurements, along with computer and network connectivity to the merchant's sales processing systems to receive transaction details and connectivity to the specified or recommended payment or transaction processing network for further authorization and transaction processing, along with a merchant signup or “on-boarding” underwriting criteria and evaluation method for each type or level of merchant or PPMA service, a security and compliance review process, optional business model or processing rules such as accounting, escrow or tax services and finally tracking or workflow systems and systems to enable and enforce business model rules such as funding rules (e.g. a time delay from PPMA purchase to activation and between buy-ups or repurchases and when transactions are enabled) along with other features that may be required or specified by a specific payment method or network or bank not related to PPMA level qualifications. Optionally operational flexibility is gained under the PPMA model by enabling the provider to “steer” or direct payments or transactions to the lowest cost provider which may be accomplished with or without the merchant's knowledge or approval. Finally, the provider may limit account processing to only debit cards (i.e. not allowing more expensive credit cards to be processed) which provides merchants with an automated way to distinguish identical looking plastic debit and credit cards, removing the burden from the merchant.

The disclosed system is a robust process for selling, managing and servicing transactions which can easily interlink into the various payments networks due to its extensible, object oriented system architecture which may utilize various networking, communication and connectivity protocols or models including but not limited to the Internet, WiFi, NFC, Bluetooth, VPN and private communication connectivity options, standards or systems. PPMA systems may utilize the most advanced data storage, processing and reporting techniques or equipment, as well as sharing, collaboration or social networking methods or tools, as well as auditing, security and profiling or monitoring tools, and general IT systems or methods known at the time, whether they are embedded into a device, provided by hardware located onsite at the merchant's location(s) or hosted in a PPMA providers office(s) or in a network cloud or other outsourced type of infrastructure. One key to implementing the PPMA system is the ability for PPMA operators to easily define, change or enforce any of the contract terms or TOS rules within the software, database, business rules, configuration settings, network or electronic connectivity routing or processing, monitoring and transaction processing systems. The PPMA system and method may be implemented and operated by ISOs, aggregators or acquiring vendors across different credit card processors, transaction and data processing networks, service providers or banks, or merchant acquiring processing switches or networks or other alternative payment networks. Thus this system and method handles merchant transactions for all payment methods or forms such as TPPA's or alternative payment networks, not just those that collect service fees for traditional Visa/MC card models.

A PPMA would also serve as an additional risk management tool that may reduce an ISO's overall work levels and effort. Currently for each open and active merchant account, the risk exposure to an ISO remains uncapped, meaning that any traditional or existing monitoring activity is focused on reviewing sales activity “after the transactions have been authorized” and submitted for settlement via deposit into the merchant's account. Thus, small merchants should be monitored just as closely as large volume merchants because at any time they may have the potential to submit a large volume of sales transactions in a short period of time, thus increasing their risk profile to the ISO. Historically, merchants have had the ability to change their business models after signup from originally agreed to models or limits or they may change what they sell or how they sell and or go defunct but they may still originate transactions without informing their ISO or acquiring agent of these changes. This means that the traditional ISO risk management method may loose track of or be less capable of monitoring the true risk levels generated by their merchant customers due to transaction monitoring “noise” generated by monitoring thousands or tens of thousands of normal transactions while looking for the “needle in a haystack” or out of bounds transaction(s) or merchant(s) among the many valid or legitimate merchants and transactions. These frequent normal transactions settle without problems but transactions may look alike before they are settled. This “noise” level can overwhelm risk managers looking at too many accounts with too many risk parameters, thus the responsible parties who monitor these transaction and or who are responsible for them would prefer a PPMA system with simplified or predefined risk levels that stop transactions before they are accepted by providers.

PPMAs would provide ISO's with a simplified and faster merchant “on-boarding” and approval process during the acquirer sales process. For the majority of small volume merchants who operate under a transaction processing system without a PPMA system and method, the risk to the ISO comes from not being able to automatically limit the amount of future payments that the merchant may process. This is in contrast to the PPMA model where, for example, the limits or rules on total dollars, size or amount of transactions would be known and agreed to upfront. With a PPMA, the merchant underwriting process becomes safer, with a known capped risk based on the sales processing volume pre-selected by the merchant. For example, a $1,000 PPMA sales package limits maximum risk to the PPMA provider of $1,000 in potential reversible or “charge-backable” sales activity and or for a known period of time such as a 3 month processing time limit or other business rules or conditions. Thus, for the ISO, having a known, quantified risk is easier to plan for and manage. Additionally, the discount or processing fees for the $1,000 PPMA services are paid upfront so no losses would occur to the provider for unpaid processing fees which occur between the time of the triggering transaction and the cut off decision to deny additional payment processing requests.

Operating a PPMA service program may lower the ongoing risk and monitoring costs of the 100% liable ISO. Risk management is improved with the ability to set parameters for topping off and or reloading the Prepaid Merchant Account with additional processing privileges. A PPMA is different, better and unique in how it simplifies the ISO sales and operating process to small merchants as well as provides an added layer of risk or compliance management because it utilizes multiple dimensions of control (e.g. time, dollar amount, transaction size or quantity and the like). It is likely that this approach has not been used before because the traditional ISO sales channel does not control the merchant billing, settlement or statement processing process, nor have they designed or operated the type of risk management systems that would be needed to implement the present invention. Thus, the PPMA merchant authorization system may be used to prepay for all kinds of payment processing services including but not limited to credit or signature debit card services (e.g. MasterCard, Visa, Discover, Amex), PIN debit or ATM card processing, EBT cards, coupons or gift cards (open and closed loop), ACH services (OLBP, EBPP, P2P, and the like), check processing services or future payment forms, systems or networks which may all be incorporated or delivered under the PPMA model. Other types of transaction processing may be offered under a PPMA model such as coupon processing, customer loyalty or reward point transaction qualification tracking and processing as well as AP or AR accounting processing services and the like.

To implement a “prepaid” merchant account, the PPMA system provider would set limits on the transaction time, counts and/or sales volume or other business units, dimensions or measurements (i.e. the “prepaid limit” or PPMA limit) that could be submitted for processing by a merchant. The business rule “limits” may also include time limits or any of the other rules or conditions within which all services would be offered before processing would be cutoff. In consideration for this predefined PPMA transaction processing limit, the merchant would pay upfront for the fees required to support or enable the transaction processing volume defined in the PPMA limit. With each payment transaction submitted by the merchant, and prior to making the network payment system connection which would authorize a specific individual transaction, a connection or API call may be made by the merchant or their POS or business system to the PPMA system to authorize the PPMA enabled merchant. This connection or API call would check or verify that the merchant and or transaction were eligible to be submitted for processing under their specific agreement and limits. If the transaction can and should be enabled, the traditional or usual transaction completion methods would be called or enabled. Alternatively, the merchant may simply submit the transaction to the PPMA provider and have them do all of the transaction validation, verification or compliance checking including determining if the transaction and or merchant's status was within the bounds of the PPMA agreement and TOS and if so have continued processing completed by the payment network, gateway or provider for normal customer and payment processing.

The PPMA system provider could establish a merchant authorization system that enforces the PPMA processing limits and therefore it could suspend service if the merchant is not in good standing or if the proposed transaction does not fit the defined limits or rules. This system may also provide functionality that may allow merchants to instantly prepay for additional (re-upping) or incremental or new or future payment processing service as needed depending on the parameters set (how often, how many times, etc.) by the PPMA system provider in their merchant agreement. The merchant authorization system should be able to produce a report letting the merchant know their prepaid balance at any time and or in advance of submitting a transaction. If a merchant submits a transaction without first checking their balance and that new transaction exceeds their PPMA processing limit, a message of the type “exceeds limit” may be returned to the merchant or downstream processing provider. The submitting merchant may then run a report to find their balance and resubmit the transaction request for a lower amount and or add more processing capacity if available to them based on parameters set forth in the PPMA agreement. Finally, the PPMA model may be automated by enabling the merchant to submit transactions in an automatic manner or be integrated into the merchant's POS system and or virtual terminal or transaction origination device including card swipe terminals, readers, scanners and the like, reducing training and implementation time for merchants. Optionally, the PPMA system and method may be integrated into mobile “App Store” like application and commerce models, or into ecommerce engines or shopping carts or other alternative payment aggregators APIs or gateways and the like to automate the delivery of PPMA services.

If the PPMA merchant authorization system does not approve the merchant's transaction, the payment transaction may never be delivered to the processing network. The PPMA system and method provider does not necessarily need the cooperation of the gateway, switch, processor or payment network operator to operate a PPMA merchant system or authorization and verification of its own rules, conditions, contract or TOS. However, the PPMA solution may be more fully integrated into the gateway and or processor, or possibly at the POS and or terminal or virtual terminal payment applications. Regardless of implementation or point of system integration, the PPMA service may need to incorporate a new user input user interface, front end, or virtual terminal and/or specific terminal applications or functions to handle the unique PPMA merchant authorization service calls, APIs, security and compliance models, status messages or reports. These new processing or input methods could be delivered under the original ISO or acquiring merchant vendor's service “on-boarding” procedures as defined by the PPMA agreement. It is well known to those skilled in the arts that this commonly would involve a simple software download and update process and or redirection of a virtual terminal page or webpage to a new Internet location which provides and implements the service.

Merchants may be able to sign up for a PPMA account as they do now for current merchant accounts. Changes to the merchant on-boarding application and screening process may include the need to add the PPMA pricing and processing plan definitions (i.e. restrictions and or defined limits or breakpoints) but in general the same sales and marketing process along with application approval process including using the same general terms and conditions and or similar underwriting process may be followed. Once the merchant is approved for service and PPMA limit parameters are set, the merchant authorization system can be self-managed by the merchant through a website, virtual terminal, or portal (for balance inquiry, reports on activity, to add or purchase additional value when allowed and other business functions) but the PPMA system provider may be required to approve or acknowledge any change to any of the parameters or limits which enable additional transactions to be approved and settled into the PPMA bank account.

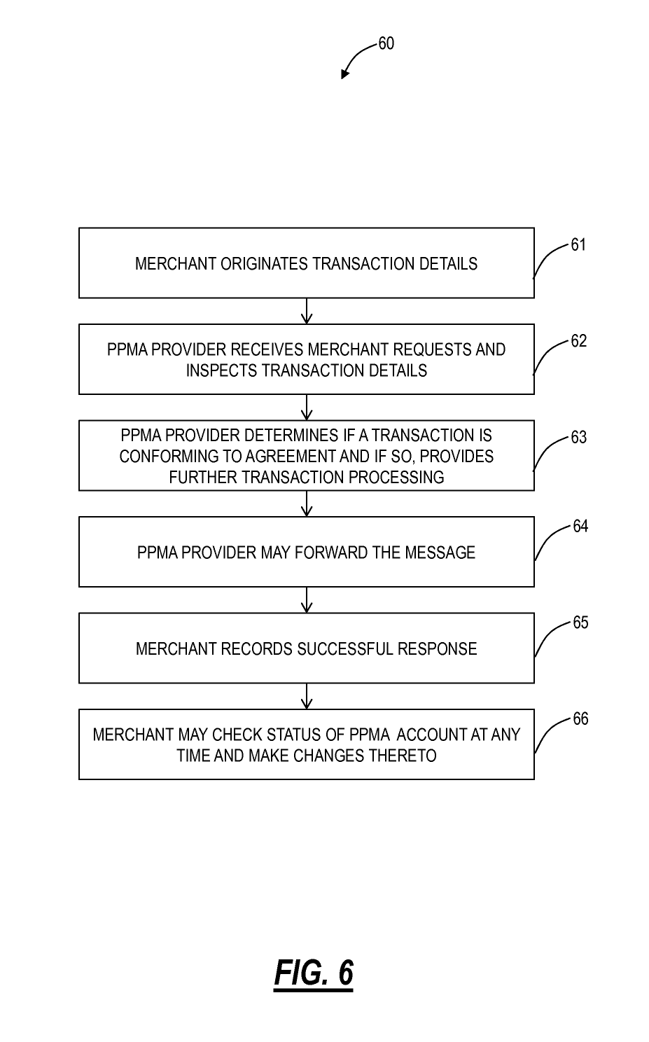

Referring to FIG. 6, in an exemplary embodiment, a flowchart illustrates data flows in a PPMA method 60. Potential processing data flows, settings or rules and limits according the PPMA would determine the flow of items or funds and use of PPMA services such as the following:

1. A merchant originates transaction details conforming to the PPMA agreed to method or optionally for backward compatibility they may originate existing or standard format transactions and ask the PPMA provider to modify or enhance them before processing may continue in order for them to conform to PPMA rules or contracts. (step 61)

2. PPMA provider receives merchant requests and inspects transaction details to determine if either the merchant, the transaction and or both are eligible under the current PPMA contract status, including PPMA provider risk or scoring assessments and amount of previous transaction levels or status before any approval and processing and a determination of the availability, amount or “room” which would be left after a potential successful transaction is processed under PPMA agreement or other rules, all of these calculations or values may be used in subsequent evaluations, monitoring and tracking (step 62)

3. PPMA provider determines if a transaction is conforming to agreement and if so, provides further transaction processing on behalf of the merchant and sends transaction to responsible processing and settlement provider for authorization and approval. Optionally the PPMA provider may modify or alter the transaction to conform to rules or eligibility terms and conditions of either the PPMA or downstream network processor. (step 63)

4. Optionally, when a PPMA provider receives a transaction response from a payment or processing network, they may forward the message, or the transaction details or a custom notification message or any and all of these back to the merchant, while also allowing the PPMA provider to record the network response or action as well as their own evaluation, actions or responses within their merchant tracking system. Optionally the payment or processing network response may be directed back to the merchant bypassing the PPMA provider and any of its automated handling systems while still having the ability to record and track the responses or actions for future evaluation or monitoring system usage. (step 64)

5. The merchant records the successful (or authorized or approved) response and closes the transaction according to their procedures, or if a negative response was received the merchant may respond to the returned message or notification and ask for or enable further processing to be performed. A merchant may respond back to the PPMA provider with a new request which may enable them to reprocess and or complete a modified or successful transaction to occur on their behalf. The merchant may respond in a manual or automated manner and the terms of the new transaction may occur under the existing PPMA contract or possible be enabled under a newly prepaid and enabled contract. (step 65)

6. Optionally, the merchant may check the status of the PPMA account at any time and change the level of service as needed based on their current business conditions. (step 66)

A service provider or bank could incorporate the present invention into the system logic it currently has in place to deduct the billing fees charged to the merchant for future account transactions. A merchant account can be established with payment for a set amount of service upfront so that the merchant will have a clear understanding of service fees and process expense exposure for a set amount of customer card charges which insures payment to the service provider while limiting their financial risk to a predetermined level. This process can be hierarchy specific in that the service provider may be already creating an electronic transaction which credits the gross/net amount of a payment transaction to the merchant's bank account at said provider's institution. The disclosed system and methods are provided by a robust, customizable architecture even under a decentralized support model such as ISO delivery or enabling banks or other parties to provide varying credit/debit facilities or accounts or hierarchies which are interlinking due to the flexible business model rules for account transactions.

An alternative embodiment of the invention may enable the ability to use proceeds from approved transactions to fund the PPMA service which allows merchants to prepay for future billings using the proceeds from the charges they have already accepted. (e.g. instead of paying to establish an account with check, money order, card or ACH debit prior to beginning to process cardholder transactions, merchants could sell goods & services which are processed at higher transaction rates or at higher fees and have the provider apply some or all of the net proceeds towards their PPMA contract). This allows the merchant to build value in a stored value PPMA account which is gathering funds until such time as the PPMA service account contract total amount has been met and all conditions satisfied. This would enable the merchant to accomplish establishing and funding a PPMA service from the cash flow or revenue of on an ongoing business. This prepay funding process may be accomplished in a number of ways.

Another embodiment of the disclosed system and method can be incorporated into a modification of credit card or payment terminal technology at the merchant's place of business. The embodiment may foreseeably include software as well as hardware modification to the terminal or a software upgrade to a virtual terminal or gateway system. The terminal provider may utilize, in one embodiment, a new function button on the terminal to enable the merchant to issue or generate new PPMA transactions. Another function of this button would allow the merchant to enter the total of his prepayment or reserve balance that they wish to increase or make, either daily or monthly or other selectable period, and transmit this information to the PPMA service provider or bank. This information transfer would facilitate the debit from the merchant's account and the credit of such amount to the prepaid or reserve account.

To accomplish the functionality of using the suggested system design on existing merchant hardware, a service provider or bank software, may allow the PPMA account holder to manage prepay and reserve increases as their business grows using additional or outside systems from their existing terminals, gateways or networks. It would be to the PPMA provider's advantage to increase their use of float by collecting 100% of the billing fees prior to service being performed by withholding funding from approved transactions. In one embodiment, to accomplish the system and method, merchants would be provided with a password or PIN to communicate to the service provider or bank, which debits the appropriate portion of sales from the merchants business checking account or daily charge deposit and which would be used to prepay for more transaction process services or placed in the merchant's reserve account to gain access to greater charge acceptance limits. Incorporating this system into the overall software and system architectural framework of, for example, a bank's system will allow the bank to impound and file all of the billing fees collected by the merchant for the account transactions. This makes the bill collecting system safer and with reduced risk because the bank is paid for the acquiring services upfront. Also, allowing merchants to manage their own reserve account balance increases will eliminate risk on the part of the service provider and may serve as a savings account for merchants (small businesses could find this savings plan to be beneficial and additional services could be provided such as interest payments, etc.). Additional embodiments may comprise any and all allocations of easily customizable parameters in real time, which can be prepaid for from merchant charges. For example, the PPMA service provider systems allocations process may use a flexible and thus customizable system for merchants to control, direct or enable new account allocations among different system implementations for payment or transaction delivery models.

The disclosed invention can be implemented via a variety of communication protocols, methods or channels (e.g. a Virtual Private Network or VPN, an SSL encrypted webpage portal or webservice connection or a simple FTP configuration file transfer process, or as embedded software in a terminal device or a virtual terminal or gateway, shopping cart and the like). The disclosed invention may be implemented across the different systems of credit card or EFT processors and the service providers or banks which process credit & debit card transactions as well as rebate, coupon or other data processing networks. To accomplish this, service providers may set prepaid prices for merchant accounts with limits placed on processing volume, transactions, ticket sizes, time frames, type of business, reserve requirements, payment types or forms, etc. Merchants will select the “package” of service and price plan that best fits their needs with the ability to upgrade, modify, change this “package” plan as needed or allowed by provider.

The system may be hard-wired to prevent the necessity of additional hardware requirements at either the merchant level or at the service provider or bank, where the account transaction may be provided by only involving interlinks of the various payment or transaction processing systems or Electronic Funds Transfer (EFT) networks and to the disclosed robust PPMA system architecture. For example, no unifying data or messaging standard is needed to be created at the input or merchant level. Data collected from merchants is inspected, processed and may be unified or converted as needed at the PPMA service provider, gateway, network or bank level before it is forwarded for presentment into the existing transaction processing or payment networks. Upon successful acceptance, authorization or approval by the network, the merchant's account may be debited in a unified manner, in one example, daily, and impounded in prepaid account until the merchant uses up their PPMA payment processing limit activity with the service provider. The software logic for deducting a certain percent of gross sales is also known as processors or banks utilize it to take their fees under existing models. The disclosed system and method recognizes the unique risk tolerance, service provider expenses, profit and merchant acquisition goals, and allows the invention to utilize customize parameters to manage these elements. Also, the PPMA system and method recognizes that different payment networks operate in different environments including both technology (as in software code, platform hardware, etc.) and terminology (name or message conventions) and thus PPMA business models, pricing or operating rules may be set to work across them. The method and system may be implemented on a merchant level or across platforms as desired or required for service provider implementation.

Another embodiment of the disclosed system and method is to provide a service to small businesses as a forced savings plan. Many small businesses are S corporations with profits flowing through to the corporate officers as income. To boost this income, a PPMA service provider could offer an additional amount to be moved into a savings account for the corporation. Many small businesses lack the discipline to save small amounts of money over time, which has been a proven method of saving money. A service provider may offer a disclosed service to deduct an extra allocatable percentage from each transaction and funnel it into a savings account for the merchant or business. Thus the PPMA provider may benefit from the “float” that this service enables as a new avenue of income for the service provider. This implementation allows them to pay interest on the savings balance or a reserve balance parameter (if a reserve is used by the service provide as a criteria to increase allowable charge volume/transaction limits) as an additional feature which could be a offered to the merchant. The PPMA prepaid processing features could be tied to this additional reserve savings account feature to provide for emergency or over limit processing to continue without interruptions. Thus, if a PPMA service provide receives a transaction which would be denied due to a limit or condition being triggered, the provider may look to this additional savings account and or a reserve account to enable them to accept the transaction and continue processing for it. For example, if a merchant subscribed to a $2,000 PPMA account and they had previously used $1950 of that processing and then submitted a new $100 payment charge for processing under their PPMA account, under normal operation the PPMA would not proceed with processing of this transaction because it would cause the PPMA limit to be exceeded, however using the reserve account and or the savings account, the extra $50 of processing risk may be covered and enable the PPMA provider to continue processing the transaction. In an alternative provider the PPMA service provider may allow it but the service provider would not fund the merchants account for the full $100 because they have agreed and have paid for only up to $2,000 of processing, so the PPMA provider would hold the $50 difference until the merchant pays additional fees and or purchases additional or extra PPMA processing services.

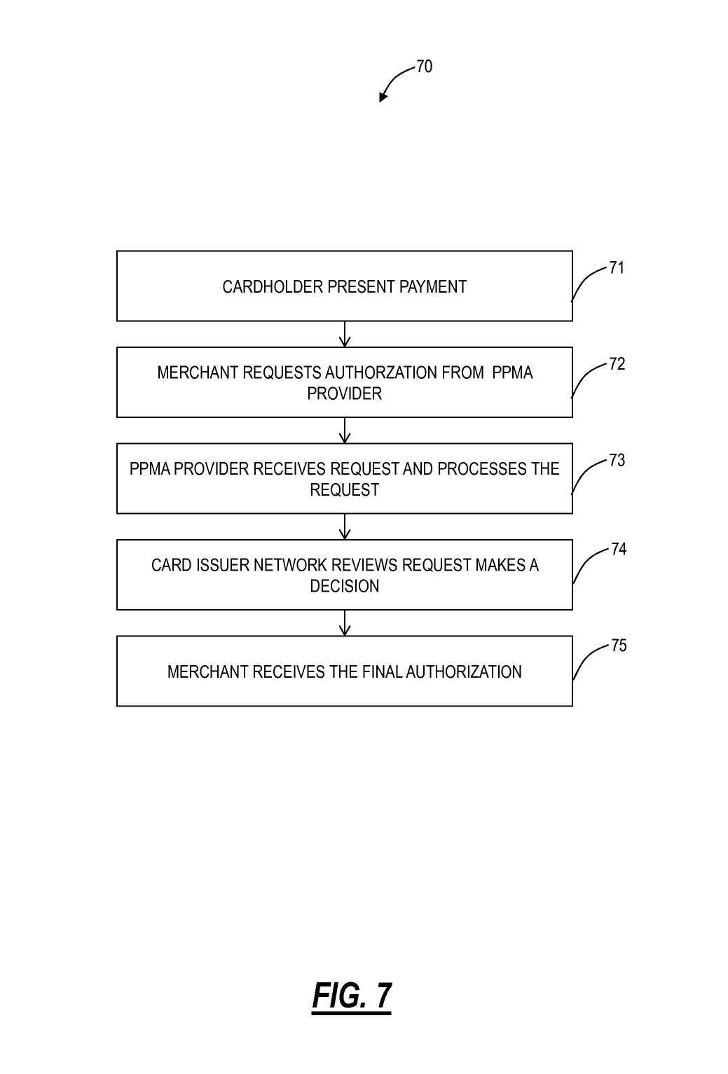

Referring to FIG. 7, in an exemplary embodiment, a flowchart illustrates an exemplary credit card authorization method 70 as follows:

1. The cardholder presents payment method details such as a Visa card (credit or debit) at the merchant's point of sale terminal, phone or into their shopping cart or checkout page. (step 71)

2. The merchant uses some form of electronic processing and network connectivity to request an authorization from their PPMA provider ISO, merchant acquirer, gateway, processor or acquiring bank and the transaction request proceeds forward for processing. (step 72)

3. The PPMA service provide may receive the request and process it utilizing the existing payment network integrated authorization or request message processing method which includes details about the account and the transaction details including merchant ID. In one embodiment, a merchant bank acquiring network integrates and interlinks to the PPMA system and method to complete the processing. In an alternative embodiment the merchant payment request is sent directly to the PPMA provider where they determine how to process it and where to send it. After PPMA processing and approval, the message is then switched, for example, through VisaNet, or other proprietary network to the card issuer for final approval and settlement. (step 73)

4. The issuer network reviews the request and makes a decision to approve or decline it in a matter of seconds; this response may be interlinked to PPMA service provider account for tracking and recording into the merchant's current PPMA account standing and when applicable the PPMA provider forwards the response back to the merchant. (step 74)

5. The merchant receives the final authorization and approval for the transaction and completes the sale. Optionally, the PPMA provider may compare the authorization result with the final settlement result as an additional check or data element used by the TOS. (step 75)

Finally, the PPMA provider's system and methods may extend into a wide range of transaction processing services. It is foreseeable that in some cases, when an issuer is unavailable for authorization, an optional implementation of the PPMA system could authorize the transaction as a part of a stand-in processing service for the non-responsive issuer's procedures. This would be done to further enhance payment system efficiency and reliability by having the PPMA provider optionally “step in” to approve and or “insure” the transaction for the merchant under a PPMA rule or condition. Authorization alternatives the PPMA may use include normal systems or channels, alternative channels, or “out of band” channels such as a telephone call and the like among other authorization choices. Additionally, the PPMA service systems and methods may be incorporated into other financial services business models or methods for both transaction approval as well as non-traditional payment transaction processing such as the financing of purchase orders (POs) or invoices or “factoring” as a way to record, inspect and approve the financing of a receivable. The PPMA provider may also use a prepaid amount to underwrite and or insure the financing service to a business. In general the PPMA process, system and method may be embedded into or used in conjunction with any form of manual or automated underwriting or “on-boarding” service process that is utilized to sell any product or service. Thus the PPMA provider's service may extend beyond approval and replace or supplement the traditional payment system authorization models and or it may augment or be passed through or into to other transaction processing systems or routes to complete a range of transaction processing.

The exemplary embodiments presented herein can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus or device. The medium can be electronic, magnetic, optical, electromagnetic, infrared, or semiconductor system (or apparatus or device) or a propagation medium. Non-limiting examples of a computer-readable medium include a semiconductor or solid state memory, magnetic tape, a removable computer diskette, a random access memory (RAM), a read-only memory (ROM), a rigid magnetic disk and optical disk. Current examples of optical disks include compact disk-read only memory (CD-ROM), compact disk-read/write (CD-R/W) and DVD. Further, exemplary embodiments include or incorporate at least one database which may store software, descriptive data, system data, digital images and any other data item required by the other components necessary to effectuate any embodiment of the present system and method known to one having ordinary skill in the art. The databases may be provided, for example, as a database management system (DBMS), a relational database management system (e.g., DB2, ACCESS, etc.), an object-oriented database management system (ODBMS), a file system or another conventional database package as a few non-limiting examples. The databases can be accessed via a Structure Query Language (SQL) or other tools known to one having skill in the art.

It will be appreciated that some exemplary embodiments described herein may include one or more generic or specialized processors (“one or more processors”) such as microprocessors, digital signal processors, customized processors, and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the aforementioned approaches may be used. Moreover, some exemplary embodiments may be implemented as a non-transitory computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor that, in response to such execution, cause a processor or any other circuitry to perform a set of operations, steps, methods, processes, algorithms, etc.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure and are intended to be covered by the following claims.

What is claimed is:

1. A computer implemented method,
registering a merchant;
receiving transaction details from the merchant;
evaluating the transaction details based on the registration of the merchant;
if the evaluating is rejected, notifying the merchant of the rejection; and
if the evaluating is accepted, forwarding the transaction details to a payment processing network.

2. The computer implemented method of claim 1, further comprising
determining a plurality of rules for evaluating the transaction details from the merchant, and
utilizing the plurality of rules in the evaluating the transaction details.

3. The computer implemented method of claim 1, further comprising
if the evaluating is rejected, resubmitting the transaction details through one of reducing a value, a size, or an amount of the transaction details.

4. The computer implemented method of claim 1, further comprising
receiving a prepayment of fees from the merchant thereby reducing an overall risk level associated with transactions for the merchant; and
evaluating the transaction details based on the prepayment of fees and rejecting the transaction details if associated fees exceed the prepayment of fees.

5. A system, comprising:
a network interface communicatively coupled to a payment processing network and a merchant via a network;
a processor communicatively coupled to the network interface; and
memory storing instructions that, when executed, cause the processor to:
register a merchant for a Prepaid Merchant Account;
receive transaction details from the merchant;
evaluate the transaction details based on the Prepaid Merchant Account;
if the transaction is rejected, notify the merchant of the rejection via the network interface; and
if the transaction is accepted, forward the transaction details to the payment processing network.

6. The system of claim 5, wherein the instructions, when executed, further cause the processor to:
determine a plurality of rules for evaluating the transaction details from the merchant, and
utilize the plurality of rules in the evaluating the transaction details.

7. The system of claim 5, wherein the instructions, when executed, further cause the processor to:
if the evaluation is rejected, receive a resubmission of the transaction details through one of reducing a value, a size, or an amount of the transaction details.

8. The system of claim 5, wherein the instructions, when executed, further cause the processor to:
receive a prepayment of fees from the merchant thereby reducing an overall risk level associated with transactions for the merchant; and
evaluate the transaction details based on the prepayment of fees and rejecting the transaction details if associated fees exceed the prepayment of fees.

9. Software stored in a non-transitory computer readable medium and comprising instructions executable by a system, and in response to such execution causes the system to perform operations comprising:
registering a merchant for a Prepaid Merchant Account;
receiving transaction details from the merchant;
evaluating the transaction details based on the Prepaid Merchant Account of the merchant;
if the evaluating is rejected, notifying the merchant of the rejection; and
if the evaluating is accepted, forwarding the transaction details to a payment processing network.

10. The software stored in a non-transitory computer readable medium of claim 9, wherein the instructions, when executed, further cause the system to perform operations comprising:
determining a plurality of rules for evaluating the transaction details from the merchant, and
utilizing the plurality of rules in the evaluating the transaction details.

11. The software stored in a non-transitory computer readable medium of claim 10, wherein the instructions, when executed, further cause the system to perform operations comprising:
if the evaluating is rejected, resubmitting the transaction details through one of reducing a value, a size, or an amount of the transaction details.

12. The software stored in a non-transitory computer readable medium of claim 12, wherein the instructions, when executed, further cause the system to perform operations comprising:
receiving a prepayment of fees from the merchant thereby reducing an overall risk level associated with transactions for the merchant; and
evaluating the transaction details based on the prepayment of fees and rejecting the transaction details if associated fees exceed the prepayment of fees.
